(19) United States
(12) Patent Application Publication
(10) Pub. No.: US 2026/0077481 A1
(43) Pub. Date: Mar. 19, 2026

(54) HUMANOID ROBOT HAVING COMMON ACTUATOR COMPONENTS

(71) Applicant: Figure AI Inc., San Jose, CA (US)

(72) Inventors: Jacob Webb, San Jose, CA (US); Shubham Jayprakash Chotia, San Jose, CA (US); Victor Ragusila, San Jose, CA (US)

(21) Appl. No.: 19/329,485

(22) Filed: Sep. 15, 2025

Related U.S. Application Data
(63) Continuation-in-part of application No. 19/038,657, filed on Jan. 27, 2025.
(60) Provisional application No. 63/694,304, filed on Sep. 13, 2024.
(60) Provisional application No. 63/852,423, filed on Jul. 28, 2025.
(60) Provisional application No. 63/852,724, filed on Jul. 28, 2025.

(51) Int. Cl. B25J 9/12

(52) U.S. Cl. CPC B25J 9/126

(57) ABSTRACT

A humanoid robot comprising an upper portion with a torso, left elbow, left fingertip, and actuators including four electrical actuators between the left elbow and fingertip (each with motor peak torque below 0.12 Nm), and two electrical actuators between the torso and left elbow (each with motor peak torque above 1.3 Nm). A lower portion includes a shin with an electrical actuator having motor peak torque above 0.75 Nm. A central portion between the upper and lower portions includes a pelvis with a hip flex electrical actuator directly coupled to the pelvis having motor peak torque above 3.5 Nm.

### CROSS REFERENCE TO RELATED APPLICATIONS

This application is (i) a continuation in part of U.S. patent application Ser. No. 19/038,657 filed Jan. 27, 2025, (ii) a continuation in part of PCT/US25/16930 filed Feb. 21, 2025, (iii) a continuation in part of PCT/US25/19793, filed Mar. 13, 2025, and (iv) claims the benefit of and priority to U.S. Provisional Patent Application Nos. 63/694,304 filed Sep. 13, 2024, 63/852,423 filed Jul. 28, 2025, and 63/852,424 filed Jul. 28, 2025, each of which is expressly incorporated by reference herein in its entirety.

### TECHNICAL FIELD

The present disclosure relates to humanoid robots, and more particularly to a humanoid robot with an optimized actuator configuration for enhanced performance and versatility in human-centric environments.

### TECHNICAL FIELD

The present disclosure relates to humanoid robots, and more particularly to a humanoid robot with an optimized actuator configuration for enhanced performance and versatility in human-centric environments.

### BACKGROUND

The labor market in the United States is currently experiencing a severe and sustained workforce shortage, with over 10 million unfilled positions across various industries. Many of these vacancies involve occupations characterized by hazardous conditions, physical strain, or tasks generally considered undesirable. This persistent labor gap has intensified the demand for advanced robotic systems capable of performing functions traditionally carried out by human workers. To effectively address these challenges, it is critical to develop humanoid robots that can operate efficiently and reliably within human-centric environments. These robots must possess advanced capabilities such as dexterous manipulation, endurance, and precise navigation in workspaces designed for human use.

Despite their promise, conventional humanoid robots face limitations in range of motion, power efficiency, and overall functionality. Addressing these deficiencies requires advancements in several key areas. First, actuator systems should be improved to provide precise control, sufficient force output, and energy efficiency within a compact form factor, enabling robots to execute complex, human-like movements. Second, the integration of advanced sensor arrays and control systems is helpful for real-time environmental perception, proprioception, and adaptive decision-making. Enhanced data collection, proprioceptive feedback, and machine learning-driven control algorithms will enable more responsive and autonomous operation in complex environments. Third, power management and energy efficiency remain challenging, necessitating innovations in battery technology, power distribution, and energy-efficient actuation to ensure long-term operation in practical settings.

A key limitation of conventional humanoid robots is the reliance on highly specialized, proprietary, or custom-designed components, which increases production complexity, cost, and maintenance challenges. The lack of standardized or widely available components restricts scalability and manufacturability, making it difficult to deploy these robots at a large scale in commercial and industrial applications. Therefore, there is a need for a humanoid robot that incorporates common components—such as standardized actuators, sensors, motors, gearboxes, power systems, and linkages—humanoid robots can benefit from economies of scale, reduced lead times, and simplified supply chains. An advanced humanoid that includes these common components can simplify manufacturing, increase assembly speed, reduce cost, and minimize the number of unique parts required. This standardization also reduces the need for excessive part SKUs, streamlining inventory management and reducing engineering complexities.

### SUMMARY OF INVENTION

The presently disclosed subject matter is directed to a humanoid robot comprising an upper portion having a torso, a left elbow, a left fingertip, and a plurality of actuators that include four electrical actuators positioned between the left elbow and the left fingertip, and each actuator includes a motor with a momentary peak torque rating that is below 0.12 Nm, and two electrical actuators positioned between the torso and the left elbow, and each actuator includes a motor with a momentary peak torque rating that is above 1.3 Nm. The robot includes a lower portion having a shin, and a plurality of actuators that include an electrical actuator positioned within the shin and having a motor with a momentary peak torque rating that is above 0.75 Nm. The robot includes a central portion extending between the upper portion and the lower portion, the central portion having a pelvis, and a plurality of actuators that include a hip flex electrical actuator that is directly coupled to the pelvis and has a motor with a momentary peak torque rating that is above 3.5 Nm.

The presently disclosed subject matter is directed to a humanoid robot comprising an upper portion having a plurality of actuators that include eight electrical actuators, each having a first momentary peak torque rating, four electrical actuators, each having a second momentary peak torque rating that is different from the first momentary peak torque, and four electrical actuators having a third momentary peak torque rating that is different from both the first and second momentary peak torques. The robot includes a lower portion including two electrical actuators having a fourth momentary peak torque rating that is different than each of the first, second, and third momentary peak torques. The robot includes a central portion extending between the upper portion and the lower portion, the central portion including two electrical actuators having a fifth momentary peak torque rating that is different than each of the first, second, third, and fourth momentary peak torques.

The presently disclosed subject matter is directed to a humanoid robot comprising an upper portion having a torso, a left elbow, and a plurality of actuators that include an electrical actuator having a portion positioned within the torso, a motor with a momentary peak torque rating that is above 2.5 Nm, and an arm axis that has a rearwardly sloped configuration, whereby a non-zero angle is formed between the arm axis and a sagittal plane of the humanoid robot, and two electrical actuators are positioned between the torso and the left elbow, and each actuator includes a motor with a momentary peak torque rating that is above 1.3 Nm. The robot includes a lower portion having a plurality of actuators that include an electrical actuator with a motor with a momentary peak torque rating that is below 1 Nm. The robot includes a central portion extending between the upper portion and the lower portion, the central portion having a pelvis, and a plurality of actuators that include a hip roll electrical actuator that has an extent that is positioned rearward of the pelvis and has a motor with a momentary peak torque rating that is above 2.5 Nm.

The presently disclosed subject matter is directed to a humanoid robot, comprising a body structure defining an upper portion, a central portion, and a lower portion, and forty-two electric actuators configured to generate motion throughout the body structure, wherein the forty-two electric actuators are classified into at least seven actuator types based on momentary peak torque output, the seven actuator types including Type A having a preferred momentary peak torque between 17 N-m and 20 N-m, Type B having a preferred momentary peak torque between 91 N-m and 112 N-m, Type C having a preferred momentary peak torque between 230 N-m and 281 N-m, Type D having a preferred momentary peak torque between 51 N-m and 62 N-m, Type E having a preferred momentary peak torque between 141 N-m and 172 N-m, Type F having a preferred momentary peak torque between 4 N-m and 5.5 N-m, and Type G having a preferred momentary peak torque between 230 N-m and 281 N-m, wherein the actuator types are distributed such that the upper portion includes all of the Type A, Type B, and Type F actuators, the central portion includes all of the Type C and Type G actuators, and the Type E and Type D actuators are distributed across the upper, central, and lower portions.

The presently disclosed subject matter is directed to a humanoid robot, comprising a body structure defining an upper portion, a central portion, and a lower portion, and forty-two electric actuators, each actuator comprising a motor, wherein the motors are classified into at least six motor types based on momentary peak torque output, the six motor types including Type H having a preferred momentary peak torque between 3.87 N-m and 4.73 N-m, Type I having a preferred momentary peak torque between 2.52 N-m and 3.08 N-m, Type J having a preferred momentary peak torque between 1.31 N-m and 1.60 N-m, Type K having a preferred momentary peak torque between 0.79 N-m and 0.97 N-m, Type L having a preferred momentary peak torque between 0.27 N-m and 0.33 N-m, and Type M having a preferred momentary peak torque between 0.09 N-m and 0.11 N-m, wherein the motor types are distributed such that the upper portion includes all of the Type J, Type L, and Type M motors, the central portion includes all of the Type H motors, the lower portion includes all of the Type K motors, and the Type I motors are distributed across the upper, central, and lower portions.

The presently disclosed subject matter is directed to a humanoid robot, comprising a body structure defining an upper portion, a central portion, and a lower portion, and a plurality of electric actuators, each actuator comprising a gearbox that facilitates a gear reduction, wherein the gearboxes are classified into at least three ratio types based on gear reduction ratios, the three ratio types including Type N having a preferred reduction ratio between 125:1 and 80:1, Type O having a preferred reduction ratio between 100:1 and 50:1, and Type P having a preferred reduction ratio between 80:1 and 20:1, wherein the ratio types are distributed such that the upper portion includes all of the Type N and Type P gearboxes, the central portion and the lower portion exclusively include Type O gearboxes, and a portion of the Type O gearboxes are also located in the upper portion.

The presently disclosed subject matter is directed to a humanoid robot system, comprising a plurality of forty-two electric actuators organized into thirty primary actuators for a main body and twelve hand actuators for a pair of hands, wherein each of the thirty primary actuators is configured for direct drive, incorporates a strain wave gearbox, includes a cross-roller bearing, and features a through-bore for passing wiring, and wherein each of the twelve hand actuators is coupled to a drive linkage, incorporates a planetary gearbox, does not include a cross-roller bearing, and does not feature a through-bore for passing wiring.

In some embodiments, a humanoid robot is disclosed that is actuated exclusively by electrical actuators and lacks a dedicated torso pitch actuator. The robot's central portion includes hip flex actuators directly coupled to a pelvis, wherein each hip flex actuator has a hip flex axis with a downward sloping outward configuration, forming a non-zero angle with a transverse plane of the robot. The central portion may also include hip roll actuators with a hip roll axis having a downwardly sloping rearward configuration. Furthermore, the robot may include knee actuators, each having a momentary peak torque greater than 220 Nm, driven by a motor with an outer diameter of 85 mm or less, and featuring a knee axis that is aligned with a sagittal plane of the humanoid robot.

In some embodiments, the actuators are distributed and classified based on performance characteristics. For instance, actuators may be categorized by different momentary peak torque ratings, with specific ratings designated for actuators positioned between the elbows and fingertips, between the elbows and the torso, and for the hip and knee joints. In other embodiments, actuators are classified by type (e.g., Type A, G, H, etc.) and distributed throughout the robot's structure, including in the head and neck assembly, arm assemblies, spine, pelvis, and hands. A majority of actuators in the upper portion may include a brushless DC motor and an optical encoder with a resolution of at least 16 bits, while a majority in the central and lower portions may include a torque sensor with a measurement range between 0-500 Nm.

In some embodiments, the robot comprises thirty primary actuators and twelve hand actuators. The primary actuators may feature a strain wave gearbox and a through-bore opening configured to house a wire harness, facilitating electrical coupling between adjacent actuators. To enhance precision, at least one primary actuator may comprise a dual-encoder assembly, with one encoder pre-gearbox and a second encoder post-gearbox to compensate for backlash. The twelve hand actuators may utilize planetary gearboxes and a drive linkage configured to under-actuate the digits of the hands, allowing them to conform to an object's shape without requiring an individual actuator for each joint.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate with, connect with, command and/or be commanded by, control and/or be controlled by, and/or interact with;

FIG. 2 is a block diagram illustrating components of the humanoid robot of FIG. 1;

FIG. 3 is a perspective view of a humanoid robot of FIGS. 1-2;

FIG. 4 is a block diagram of sensors for the humanoid robot of FIGS. 2-3B;

FIG. 5 is a block diagram of a communication interface for the humanoid robot of FIGS. 2-3B;

FIG. 6 is a perspective view of the kinematic chains of the robot of FIG. 1, showing peak actuator torques contained in the robot;

FIG. 7 is a perspective view of the kinematic chains of the robot of FIG. 1, showing peak motor torques contained in the robot;

FIG. 8 is a perspective view of the kinematic chains of the robot of FIG. 1, showing gearbox reduction ratios contained in the robot;

FIG. 9 is a perspective view of the kinematic chains of the robot of FIG. 1, showing gearbox type contained in the robot;

FIG. 10 is a perspective view of the kinematic chains of the robot of FIG. 1, showing whether or not each actuator contains a cross-roller bearing; and

FIG. 11 is a perspective view of the kinematic chains of the robot of FIG. 1, showing whether or not each actuator contains a through-bore wire.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of handling undesirable and hazardous tasks, or (ii) advanced robots capable of generating data that can be utilized to develop cutting-edge artificial intelligence models (e.g., LLMs, VLMs, VLAs, and/or BAMs) to enable these robots to operate autonomously in human-centric environments.

The following undesirable and hazardous tasks may include walking long distances and obtaining objects from bins, among other general or specific tasks defined to an operational environment. These robot tasks may include single robot task or multiple robot tasks in a generally human-centric environment and may be dangerous, routine, and/or repetitive tasks. Unlike traditional automation systems, the humanoid robot tasks may be dexterous, human-like tasks that demand advanced motor skills, environmental adaptability, and decision-making processes. Examples of such robot tasks include, but are not limited to, assembling components (e.g., automotive parts) in a production line, welding, painting, precision machining, or operating heavy machinery. The task may also include gathering and packing items from storage bins, transporting items between storage and staging areas or in customer service roles by providing real-time assistance to human customers, such as giving directions, answering queries, and facilitating checkout processes. In other commercial or retail settings, the robots may perform tasks such as stocking shelves, unloading delivery vehicles, conducting inventory counts, rearranging displays, and sanitizing high-touch areas. In non-industrial settings, the robot tasks may include tidying up spaces, putting away groceries, cleaning, folding clothes, making beds, preparing meals, organizing closets, and/or setting tables.

These robots may include general-purpose humanoid robots specifically tailored for human-centric environments. General-purpose humanoid robots may emulate the human form and functionality, featuring two legs, two arms, and a screen. This emulation may necessitate the integration of various actuators within the robot to closely replicate human movements and capabilities. The requirement for actuators extends beyond cosmetic resemblance, as the actuators enable the robot to manipulate its arms, legs, and other assemblies to interact seamlessly with diverse objects in complex environments.

The challenge of enabling humanoid robots to execute human movements and capabilities may be compounded by the vast array of potential positions, locations, and states the robot could occupy in a dynamic operating environment. These permutations can be reduced through training methodologies, such as: (i) imitation learning or teleoperation, (ii) supervised learning, (iii) unsupervised learning, (iv) reinforcement learning, (v) inverse reinforcement learning, (vi) regression techniques, or (vii) other established methods. While training can help minimize these permutations, improper or non-optimal configurations of parts, assemblies, and components may negate the benefits of training and render specific tasks infeasible. Therefore, it may be beneficial to optimize the arrangements of parts, assemblies, and components, particularly in the robot's kinematic chains, to ensure that the humanoid robot can replicate human movements and perform a wide range of tasks. Without such optimized kinematic configurations, advanced robots may not meet the operational requirements. Thus, the inclusion of at least one optimized component or assembly, such as a single actuator, a hand, or an arm, may be desirable.

The optimized component or assemblies of the humanoid robot 1 may comprise multiple systems, assemblies, components and/or parts that may have anthropomorphic characteristics to enable said robot 1 to emulate the human form and perform a diverse set of tasks. These systems, assemblies, components and/or parts may include a head/neck 10, torso 16, left and right arms, which each include a shoulder 26, upper humerus 30, lower humerus 36, upper forearm 40, lower forearm 46, wrist 50, and hand 56. The robot 1 also includes a spine 60, pelvis 64, left and right hips 70, and left and right legs, which each include an upper thigh 76, lower thigh 80, shin 84, talus 88, and foot 92.

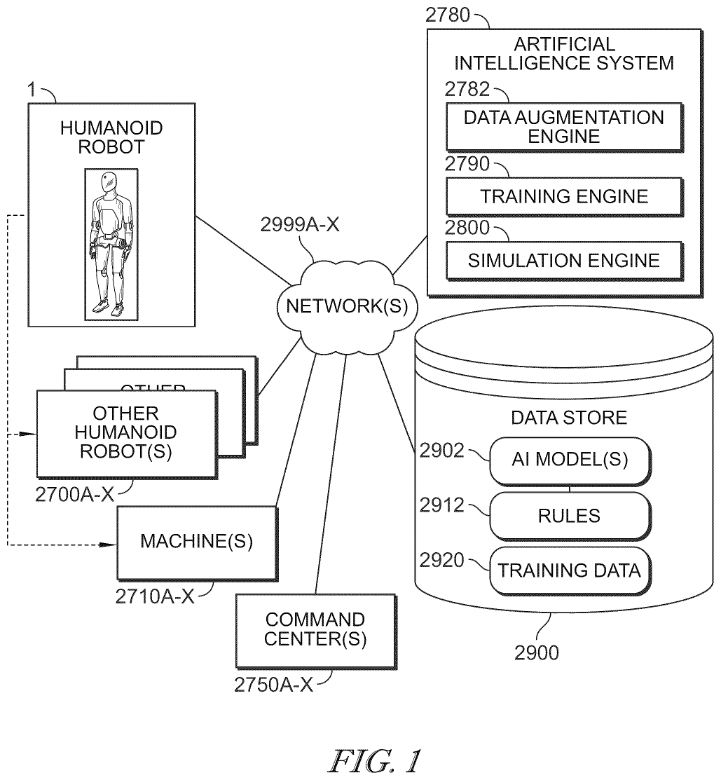

The positional relationship of the actuators within the robot 1 and their positional relationship to one another provides said robot 1 with a substantial advantage over conventional robots. As shown in at least FIGS. 1-4 and explained below, the humanoid robot 1 includes 62 degrees of freedom (DoF). In particular, the 62 degrees of freedom are distributed within the robot 1 as follows: (i) 48 degrees of freedom are contained in the upper portion 2 of the robot 1, (ii) 10 degrees of freedom are contained in the central portion 3 of the robot 1, and (iii) 4 degrees of freedom are contained in the lower portion 4 of the robot 1. The number and distribution of the degrees of freedom provide the robot 1 several significant advantages over conventional robots. For example, positioning 77% of the degrees of freedom in the upper portion 2 of said robot 1 allows it to perform complex, dexterous tasks that could not be performed without a substantial majority of the degrees of freedom being positioned in said upper portion. As another example, minimizing the number of degrees of freedom in the central portion 3 allows the robot 1 to have a larger torso 16, which allows for the inclusion of a larger battery pack and additional computing power; thereby improving the performance and reliability of the robot 1. As a further example, including at least 5% of the degrees of freedom within the lower portion 4 of the robot 1 allows it to minimize the time and number of steps required for turning around, which allows the robot 1 to have more humanlike movements and increases the speed at which certain tasks can be accomplished.

As shown in FIGS. 1-4, the 62 degrees of freedom of the inventive robot 1 are provided by a combination of 42 electric rotary actuators (J1-J16). Of the 42 electric actuators, a majority (e.g., over 60%) are not configured to drive a linkage; instead, said actuators are designed to directly drive the next part(s) of the robot 1. In particular, linkages are coupled to: (i) 14 rotary actuators of said 42 rotary actuators. In other words, 33% of the rotary actuators are coupled to a linkage. These linkages allow: (i) the fingers and thumb to be under-actuated, or in other words, the fingers and thumb retain their ability to flex, curl, or rotate around an object while eliminating the need for an actuator to control each joint or degree of freedom, and (ii) the foot to pivot around an axis that is located well forward (e.g., more than 10% of the overall length of the foot) of the center of the drive linkage.

As shown in FIGS. 5-11, the 42 electric rotary actuators can be classified into seven primary types, wherein the different types of actuators can be identified by the different types of stippling in each of these Figures. The similarities and commonalities of the various actuators and their unequal distribution provides substantial benefits to the robot 1 over conventional robots that lack these features and configuration. Additionally, the robot 1 only uses electric actuators, whereby the robot 1 lacks manual, hydraulic or pneumatic actuators. The use of only electric actuators: (i) reduces assembly, maintenance, weight and cost, and (ii) increases durability and safety considerations related to operating the robot 1 within or around other humans.

In addition to optimized kinematic configurations, the robot may have high-precision actuators paired with real-time sensor feedback loops and a control system. The sensors may be designed to continuously monitor the robot's orientation, speed, and force exerted on one or more robot components (e.g. arm assembly, leg assembly, etc.). The control system may comprise a computing device including a processor and memory, and instructions, when executed in the computing device, to receive data from a plurality of sensors and control the actuators to affect movement of one or more of the robot components. The computing device of the robot may reside in a networked environment and execute additional instructions and/or applications not disclosed herein. The data collected can be processed by an advanced computing architecture, residing in the networked environment, to further train the neural networks that enable the robot to perform its tasks (e.g., enabling it to walk more human-like, climb stairs, or traverse uneven terrain with fluidity and stability) or said data may be used to train other neural networks that are designed to control different robots. Additionally, the disclosed advanced robots may also address technical challenges related to dexterity and object manipulation. For example, the disclosed robots may include end effectors that feature multi-jointed designs with a high number of degrees of freedom, enabling complex and precise movements. Additionally, tactile sensors may be embedded in the said end effectors to provide detailed feedback on pressure, texture, and temperature, which again can be used to train local or remote neural networks to improve execution of the set of tasks and/or response to other sensor input.

It should be understood that the disclosed configurations for the humanoid robot, including its kinematic arrangement, torque specifications, and component choices, are not merely arbitrary design selections but rather the outcome of a deeply integrated systems engineering approach. The arrangement of the forty-two actuators is strategically designed to emulate human anatomy, which is considered advantageous for performing a wide range of general tasks in human-centric environments. For instance, joints necessary for locomotion and supporting the robot's mass, such as the hip flex (J11) and knee (J14), are equipped with high-torque Type G actuators (204-307 N-m). Altering the torque capacity of these specific actuators would directly impact the robot's fundamental ability to walk or bear weight, necessitating a significant redesign of its locomotion algorithms and potentially its entire lower body structure to compensate for reduced power or increased weight.

This interdependence is further illustrated by the direct mathematical and physical relationship between the peak actuator torque, the peak motor torque, and the gearbox reduction ratio. The final output torque at a joint is a function of the motor's output multiplied by the gear reduction. For example, the powerful Type G actuators in the legs are driven by Type H motors, which have a peak torque of 3.44-5.16 N-m, and are coupled with Type O gearboxes that provide a reduction ratio between 150:1 and 20:1. A decision to change just one of these values would trigger a cascade of required significant modifications that likely cannot be made within the given design envelope. Increasing the motor's torque might require a larger, heavier motor, which would alter the limb's inertia and the robot's overall weight distribution, impacting balance and energy consumption. Conversely, achieving the same output torque with a weaker motor would demand a higher gear reduction ratio, which could limit the joint's maximum speed and compromise the robot's dynamic responsiveness during movement.

Furthermore, the mechanical and electrical architecture demonstrates how a single component choice influences the entire system's physical design. A substantial majority of the primary actuators (J1-J16) are designed as a unified module incorporating a Strain Wave Gearbox, a cross-roller bearing, and through-bore wiring. This configuration is chosen for its precision, load-handling capability, and its ability to simplify the robot's wiring harness by passing cables directly through the center of the actuator. If a designer were to replace a Strain Wave Gearbox with a solid-shaft planetary system, it would not only change the joint's performance characteristics but could also eliminate the possibility of using through-bore wiring. This would compel a complete redesign of the wiring harness to be routed externally, introducing risks of snagging and wear, and requiring modifications to the robot's structural housing to accommodate the external cables. Similarly, the choice to use cross-roller bearings is tied to the specific load requirements of these high-torque joints; changing the gearbox or the joint's function would necessitate a re-evaluation and likely a replacement of the bearing system itself. Therefore, each specified value and component is part of a complex, balanced system where a single modification would ripple through the robot's design, demanding significant and holistic alterations. Any change would require careful analysis and verification of the change in light of the complex realities of designing, testing, manufacturing, and certifying a robot for the completion of usable work nearby or around humans. Theoretical designs that attempt to implement such modifications are insufficient, and in some instances, woefully insufficient, because they amount to mere design exercises that are not tethered to the complex realities of successfully designing, manufacturing, and testing a robot.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: is a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

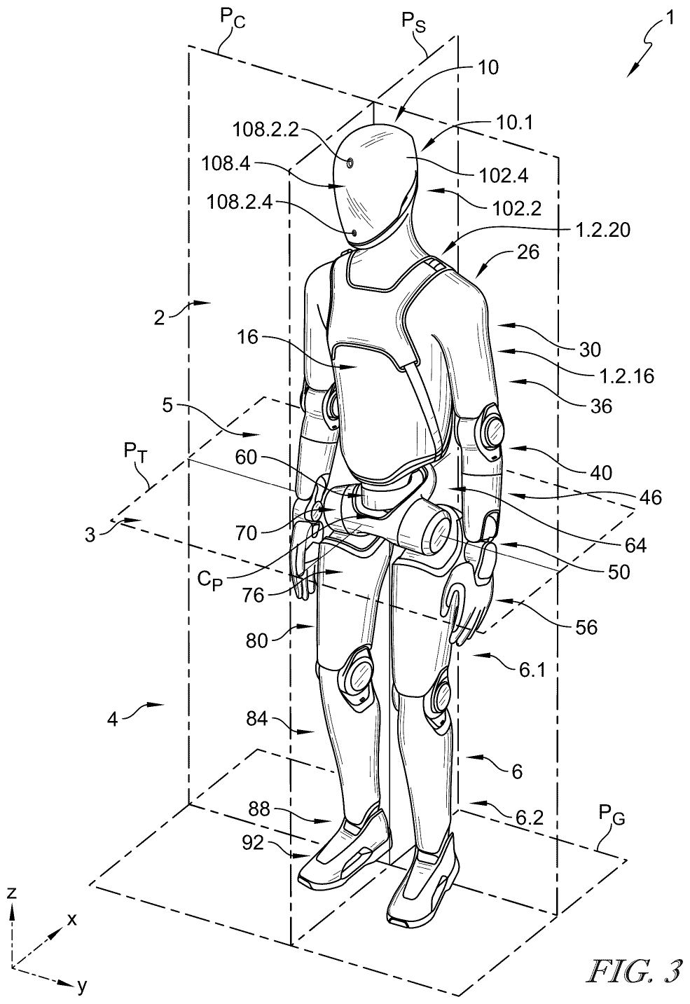

Neutral State: a state where the robot is standing upright on a horizontal support surface and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g. FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A11) and a right hip flex actuator (J11) axis (A11) and rotational axis A₁₀ of torso twist actuator (J10) located in the spine 60 of the robot 1. In the illustrative embodiment, the coronal plane (P_{C}) is a plane that is colinear with the rotational axes A₁₁ of the hip flex actuators (J11) and rotational axis A₁₀ of torso twist actuator (J10). Also, as shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position expressed in radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

FIG. 1 illustrates an exemplary network and/or operational environment in which a humanoid robot (also referred to as a bipedal robot) 1, which is further detailed in additional FIGs. herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2780 to build, train, alter, fine-tune, or modify a previously generated model, a new model, and/or rules. Advantageously, the simulation engine 2800 may is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

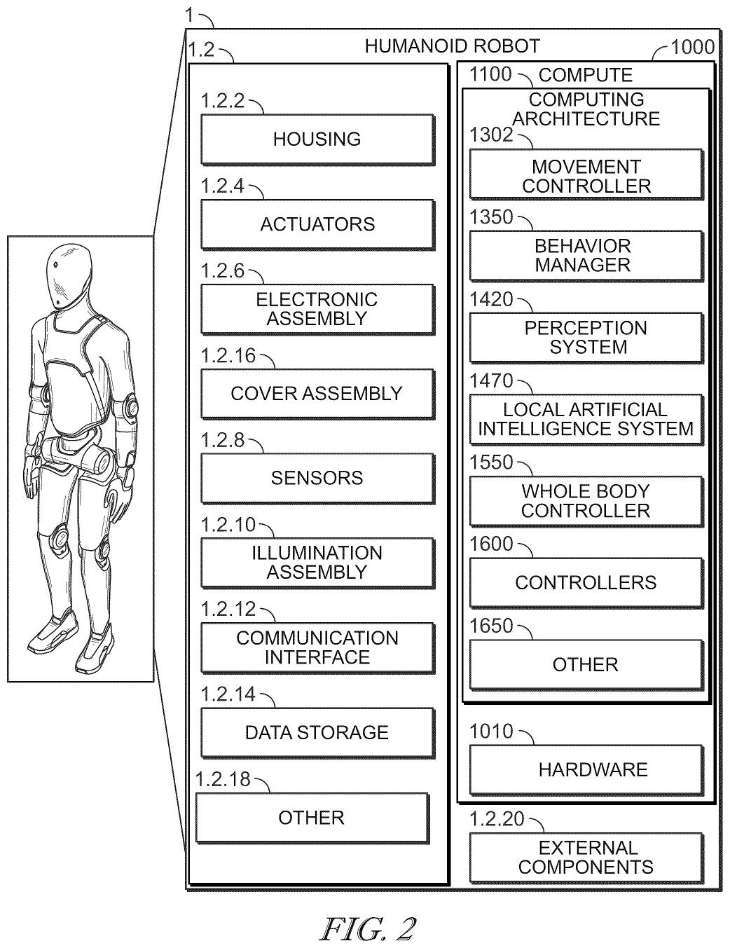

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about the coronal plane (P_{C}) and X-Y planes that intersect the head and are parallel to the transverse plane (P_{T}). The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist 74 and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1.2.10 (which includes CPUs and GPUs), power distribution unit, and a charging system. The components are strategically positioned to optimize space and balance. The battery pack may be rearwardly offset, positioned in a rear section of the torso 16, while the compute 1.2.10 is placed in a forward section. This spatial distribution helps to maintain a balanced posture, allows for efficient cooling, and maximizes the size and power density of the battery pack. A cooling system may be integrated between the battery pack and the compute 1.2.10 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

ii. Kinematics

As illustrated in, e.g., FIGS. 3A and 3B, an upper portion of the torso 16 is designed to receive and secure two arm actuators (J1) 190, wherein each arm assembly 5 extends from its respective arm actuator (J1) 190 and comprises a series of actuators that are arranged to provide extensive mobility and dexterity. Each arm actuator (J1) 190 is engineered to provide the principal rotational movement for the entire respective arm assembly 5. Each arm actuator (J1) 190 may utilize a motor, a gear reduction system, and sensors or encoders that are similar to other actuators in the robot 1, but potentially with a larger motor and a different gear ratio that is specifically optimized for high-torque shoulder movements.

The rotational axis A₁ of the arm actuator (J1) 190 is oriented at a rearward angle (α) with respect to a vertical or coronal plane P_{C}. This angle α is intentionally selected such that the rotational axis A₁ is neither orthogonal nor parallel to the other arm axes (A₂-A₇) and a is chosen from a range of between 1 and 45 degrees, with a preferred range between 10 and 20 degrees. This specific rearward angle strategically positions a primary kinematic singularity of the arm 5 in the illustrative embodiment of robot 1 at a location that is away from an intended primary operational workspace of the robot 1. This configuration is beneficial because it places that singularity of the robot's arm in a location that is outside of normal use for the tasks that the robot 1 is tasked with performing. For example, when the robot 1 holds an object with a narrow grip, it is significantly less likely to encounter this performance-degrading singularity.

Generally, an upper portion of the arm assembly 5 includes three actuators (shoulder actuator J2, upper arm twist actuator J3, elbow actuator J4), while a lower portion of said arm assembly 5 includes three actuators (lower arm twist actuator J5, wrist flex actuator J6, wrist pivot actuator J7). The rotational axes A₂, A₄ of shoulder actuator J2 and elbow actuator J4, respectively, are arranged such that they are orthogonal to: (i) the rotational axis of A₃ of upper arm twist actuator J3. In addition, the rotational axis A₃ is collinear with the rotational axis A₅ of lower arm twist actuator J5 when the arm is fully extended. The rotational axis A₄ of elbow actuator J4 is oriented orthogonal to the collinear rotational axes A₃ and A₅. Additionally, the axis A₄ is offset rearward along the X-axis from a common cord that is defined by the alignment of A₃ and A₅. This rearward placement of the elbow axis A₄ increases its range of motion. The three actuators (J5, J6, J7) situated in the lower portion of the arm are arranged with their respective axes (A₅, A₆, and A₇) mutually orthogonal to one another, which provides three degrees of freedom and enables complex orientation of the lower arm and the hand 56. This arrangement allows for control of roll via lower arm twist actuator (J5) 468, pitch via wrist flex actuator (J6) 484, and yaw via wrist pivot actuator (J7) 520, thereby governing the final position of the hand 56. In the wrist 50, the rotational axis A₅ of lower arm twist actuator J5 is positioned orthogonal to the rotational axis A₇ of the wrist pivot actuator J7. The elbow axis A₄ and the wrist pivot axis A₇ are parallel to one another in the extended state but are not aligned within the same ZY-plane.

The central portion of the robot 1 includes the torso lean actuator J9, the torso twist actuator J10, the hip flex actuators J11, and hip roll actuators 12. The torso lean actuator (J9) 680 is positioned in the pelvis 64 and is coupled to the spine 60, while a torso twist actuator (J10) 620 is located in the waist 74 of the robot 1 and is coupled to the spine 60. These two actuators, J9 and J10, are positioned to provide two degrees of freedom for the torso (i.e., torso twist (yaw) and torso lean (roll)) and are centered along the sagittal plane P_{S}, enabling capabilities such as allowing the robot 1 to twist its body to pick up an item that is positioned at 90 degrees to its side and to lean over an obstacle to complete another task. Their respective axes are arranged such that axis A₉ (torso lean) is angled downward such that an angle (θ) is formed with respect to the transverse plane (P_{T}) at an angle of between 1 and 30 degrees, preferably 8-16 degrees, while axis A₁₀ (torso twist) is parallel with the coronal plane P_{C} and perpendicular to the transverse plane (P_{T}).

The disclosed robot 1 lacks a dedicated torso pitch actuator that would allow the robot 1 to bend forward (i.e., in a ZX-plane from the neutral state) at the robot's belly. The elimination of this actuator can increase the internal volume of the torso 16 by over 300% (e.g., from approximately 7 liters to approximately 20 liters). This expanded volume allows for the inclusion of a relatively larger battery pack and relatively larger volume for compute. This lack of a torso pitch actuator would be a significant sacrifice, but for the ability to generally move this functionality into the robot's hips, specifically hip flex actuators (J11) 720. By rotating both hip flex actuators (J11) 720 in concert, the robot 1 can effectively bend its entire upper body forward from the hips. While the functionality of hip flex actuators (J11) 720 does not fully replace the inclusion of a specific torso pitch actuator because it alters the location from where the robot 1 can bend forward, the designer of the disclosed robot 1 made this trade-off in order to gain the above-described benefits. It should be understood, however, that said robot 1 could be modified to include a torso pitch actuator to add this additional functionality if needed.

As illustrated in FIGS. 3A and 3B, the hip flex actuators (J11) 720 are coupled to the left and right sides of the pelvis 64. Each rotational axis A₁₁ of hip flex actuators (J11) 720 is positioned at a respective downward angle such at an angle (γ) is formed with respect to the transverse plane (P_{T}) of between 1 and 30 degrees, preferably 8-16 degrees, a configuration to provide a pitch-like motion (e.g., extension and flexion, front kick or a torso 16 forward lean motion). Each axis A₁₁ is also offset from axes A₁₀ and A₉ along the Z-axis, which helps position the leg directly beneath a frontal extent of the torso 16. In an unconventional arrangement, the hip flex actuators (J11) 720 are directly coupled to the pelvis 64 and are positioned closer to the torso lean actuator (J9) than are any other leg actuators. This high placement (e.g., relative to the leg assemblies 6) within the kinematic chain increases the torque requirements for the hip flex actuators (J11) 720 actuators, which are sized accordingly with approximately twice the torque capacity of the hip roll actuators (J12) 768 and leg twist actuators (J13) 782.

The hip roll actuators (J12) 768 can each independently provide roll-like movement (e.g., abduction and addiction, hip pivot, sideways kick) about rotational axis A₁₂ for the portions of the respective leg assemblies 6 that are moved about the hip roll actuators (J12) 768. In the illustrative embodiment of robot 1, the hip roll actuators (J12) 768 are each coupled to a respective hip flex actuator (J11) 720, rather than being coupled directly to the pelvis 64. This arrangement allows the hip roll axis A₁₂ to be angled rearward and downward relative such that an angle (δ) is formed with respect to the transverse plane (P_{T}) of between 1 and 45 degrees, preferably 10-20 degrees. Hip roll axis A₁₂ is neither parallel nor orthogonal to any other of the actuators J13, J14, J15, J16, each described in further detail below. This specific configuration provides a greater range of motion for actions such as performing deep squats and rising from the ground, which further compensates for the absence of a dedicated spine pitch actuator.

A left and right leg twist actuator (J13) 782 is positioned near actuator (J12) 768 within the hip housing and is coupled to the lower thigh 80. Its rotational axis, A₁₃, is parallel with the torso twist axis A₁₀. Each leg twist actuator (J13) 782 can each independently provide a yaw movement about rotational axis A₁₃ for lower portions of the respective leg assembly 6 that are moved about the leg twist actuator (J13) 782. Each leg twist actuator (J13) 782 is not directly coupled to the pelvis 64, and each is positioned below all of the other hip and spine actuators (J9-J12). This is different than conventional robots and is potentially less desirable due to the fact that it increases the weight in the lower leg, which increases the torque requirements of the other actuators contained in the hip. However, in this configuration, as described above, the hip flex actuator (J11) 720 has been configured with a greater torque to address this issue. This particular design may also require any hip housing to be split into two separate components, which may add a degree of manufacturing complexity and cost.

Each leg assembly 6 of the robot 1 includes a knee actuator (J14) 820 with a rotational axis A₁₄ which is housed in the lower thigh 80. Unlike conventional designs that often utilize linear actuators or linkages for knee joints, knee actuator (J14) 820 is a rotary actuator that is directly coupled to housings of the lower thigh 80 and the shin 84 and provides a pitch movement about rotational axis A₁₄.

Each leg assembly 6 of the robot 1 includes a foot assembly which includes a foot flex actuator (J15) 860 with a rotational axis A₁₅, which is housed in the shin 84 and utilizes a rotary actuator and an associated linkage to provide a pitch movement (e.g., flexion and extension) for the foot 92 which is not about the rotational axis A₁₅. Each foot 92 further includes a foot roll actuator (J16) 900 with a rotational axis A₁₆, which is housed within the talus 88 and provides a roll movement for respective portions of the foot 92 that are moved about the foot roll actuator (J16) 900. Placing the roll actuator (J16) 900 in the foot is an uncommon design solution that tends to increase the torque requirements on other leg actuators (J11, J12, J14). However, the housing of actuator (J16) 900 is advantageously designed to couple directly to the output of actuator (J15) 860, a configuration that reduces the total number of parts and minimizes potential failure modes.

The humanoid robot 1 may further include head and neck actuators to complete its human-like form. For example, a head twist actuator (J8.2) 140 with a rotational axis A_{8.2} and a head nod actuator (J8.1) 120 with a rotational axis A_{8.1} may be included to provide two degrees of freedom (e.g., yaw and pitch, respectively) to orient sensors, cameras, or displays that are housed within the head 10.1. Although the head 10.1 and neck are not intended to manipulate objects, the head 10.1 completes the human-like form and may contain components such as cameras, displays, or other user interfaces. The head twist actuator (J8.2) 140 and the head nod actuator (J8.1) 120 may be used to direct the field of view of one or more cameras or sensors that are contained within the head 10.1 and may cooperate with each other, but they are not generally linked to other actuators.

iii. Range of Motion

The table provided below identifies the actuators 130 and their associated ranges of motion. It should be understood that the listed ranges of motion are exemplary and are provided to demonstrate the capability of the robot 1 not only to possess a significant number of degrees of freedom but also to ensure that each degree of freedom is associated with a significant range of motion. The disclosed ranges of motion enable the robot 1 to perform complex movements that closely approximate human biomechanics, with angular displacements that permit fluid transitions between operational states. This characteristic stands in stark contrast to conventional robots that often lack these large ranges of motion, a limitation which prevents said conventional robots from completing the complex, human-like tasks that the disclosed robot 1 is capable of performing.

TABLE 1

| | | | | | Preferred | Preferred | Preferred |
|---|---|---|---|---|---|---|---|
| | | First | Second | Range of | First | Second | Range of |
| Actuator | | Angle | Angle | Motion | Angle | Angle | Motion |
| (J1) | 190 | −3.77 | 1.88 | 5.65 | −3.46 | 1.73 | 5.18 |
| (J2) | 280 | −1.15 | 3.05 | 4.20 | −1.06 | 2.79 | 3.85 |
| (J3) | 320 | −0.63 | 3.25 | 3.87 | −0.58 | 2.98 | 3.55 |
| (J4) | 374 | −3.04 | 0.21 | 3.25 | −2.78 | 0.19 | 2.98 |
| (J5) | 468 | −3.16 | 3.16 | 6.33 | −2.90 | 2.90 | 5.80 |
| (J6) | 484 | −2.09 | 2.15 | 4.24 | −1.92 | 1.97 | 3.89 |
| (J7) | 520 | −1.57 | 1.68 | 3.25 | −1.44 | 1.54 | 2.98 |
| (J8.1) | 120 | −0.84 | 0.84 | 1.68 | −0.77 | 0.77 | 1.54 |
| (J8.2) | 140 | −0.94 | 0.94 | 1.88 | −0.86 | 0.86 | 1.73 |
| (J9) | 680 | −0.63 | 0.63 | 1.26 | −0.58 | 0.58 | 1.15 |
| (J10) | 620 | −1.88 | 1.88 | 3.77 | −1.73 | 1.73 | 3.46 |
| (J11) | 720 | −4.78 | 0.69 | 5.47 | −4.38 | 0.63 | 5.01 |
| (J12) | 768 | −0.77 | 1.81 | 2.59 | −0.71 | 1.66 | 2.37 |
| (J13) | 782 | −1.88 | 1.88 | 3.77 | −1.73 | 1.73 | 3.46 |
| (J14) | 820 | 0.00 | 2.83 | 2.83 | 0.00 | 2.59 | 2.59 |
| (J15) | 860 | −1.26 | 0.84 | 2.09 | −1.15 | 0.77 | 1.92 |
| (J16) | 900 | −0.94 | 0.94 | 1.88 | −0.86 | 0.86 | 1.73 |

It should be understood that in other embodiments, additional components and axes, such as rotational axes, may be utilized to further enhance the robot's operational capabilities. For example, an actuator may be added and located within the belly of the robot 1 to provide additional torso flexion and extension capabilities. Such an actuator may enable enhanced forward bending motions that facilitate object retrieval from ground level. In other embodiments, the robot 1 may include fewer components and axes, such as rotational axes, to optimize for specific applications or reduce manufacturing complexity. For example, the torso lean actuator (J9) 680, the foot roll actuator (J16) 900, or an actuator located within the hand 56 may be removed when the intended application does not demand such degrees of freedom.

It should also be understood by those of skill in the art of designing humanoid robots that each portion of the robot 1 has a different number of degrees of freedom, a specific range of motion, and a unique arrangement of its axes of rotation that collectively define the robot's kinematic capabilities. Said degrees of freedom, ranges of motion, and arrangements of axes of rotation are either directly or indirectly (e.g., via a drive linkage) associated with an actuator that provides the motive force for joint movement. The drive linkages may include cable drives, belt drives, chain drives, or gear trains that transmit power from the actuator to the joint. It is understood that the number and location of degrees of freedom, the number and location of actuators, the ranges of motion, and the arrangement of axes of rotation associated with the disclosed humanoid robot 1 materially and substantially differ from those associated with a non-humanoid robot due to the fundamental differences in morphology and functional requirements. As such, the structures, number and location of degrees of freedom, number and location of actuators, ranges of motion, and arrangements of axes of rotation associated with a non-humanoid robot cannot be simply adopted or implemented into a humanoid robot 1 without careful analysis and verification against the complex realities of designing, testing, and manufacturing a general-purpose humanoid robot. The verification process may include finite element analysis, dynamic simulation, prototype testing, and iterative design refinement. Theoretical designs that attempt to implement such modifications from a non-humanoid robot are insufficient, and in some instances woefully insufficient, because they amount to mere design exercises that are not tethered to the complex realities of successfully designing, testing, and manufacturing a general-purpose humanoid robot capable of operating in human environments.

iv. Degrees of Freedom

The high-level configuration of the robot 1 provides between 30 and 70 degrees of freedom (DoF), and preferably includes a total of 62 degrees of freedom provided by 42 rotary actuators that generate controlled angular displacements at each joint. The specific distribution of these degrees of freedom has been optimized through extensive kinematic analysis and task-based performance studies. In particular, the 62 degrees of freedom are distributed within the illustrated embodiment of robot 1 as follows:
Upper Portion 2: 48 degrees of freedom (preferably above 50% of total DoF, most preferably above 65% of total DOF, and in the illustrated embodiment, approximately 77% of the total DoF)
   Head/Neck 10: 2 degrees of freedom (preferably below 5% of total DoF, preferably above 2% of total DoF, and in the illustrated embodiment approximately 3% of the total DoF)
   Each Arm Assembly 5: 7 degrees of freedom (preferably below 15% of total DoF, preferably above 5% of total DoF, and in the illustrated embodiment approximately 11% of the total DoF)
      Each Shoulder 26: 2 degrees of freedom (preferably below 5% of total DoF, preferably above 2% of total DoF, and in the illustrated embodiment approximately 3% of the total DoF)
      Each Upper Arm Assembly 24: 2 degrees of freedom (preferably below 5% of total DoF, preferably above 2% of total DoF, and in the illustrated embodiment approximately 3% of the total DoF)
         Each Upper Humerus 30: 1 degree of freedom (preferably below 5% of total DoF, preferably above 1% of total DoF, and in the illustrated embodiment approximately 2% of the total DoF)
         Each Elbow 39: 1 degree of freedom (preferably below 5% of total DoF, preferably above 1% of total DoF, and in the illustrated embodiment approximately 2% of the total DoF)
      Each Lower Forearm 46: 1 degree of freedom (preferably below 5% of total DoF, preferably above 1% of total DoF, and in the illustrated embodiment approximately 2% of the total DoF)
      Each Wrist 50: 2 degrees of freedom (preferably below 5% of total DoF, preferably above 2% of total DoF, and in the illustrated embodiment approximately 3% of the total DoF)
   Each Hand 56: 16 degrees of freedom (preferably below 50% of total DoF, preferably above 10% of total DoFand more preferably above 17% of total DoF, and in the illustrated embodiment approximately 26% of the total DoF)
      Each Finger: 3 degrees of freedom (preferably below 10% of total DoF, preferably above 2% of total DoF, and in the illustrated embodiment approximately 5% of the total DoF)
      Thumb: 4 degrees of freedom (preferably below 10% of total DoF, preferably above 2% of total DoF, and in the illustrated embodiment approximately 6% of the total DoF)
Central Portion 3: 10 degrees of freedom (preferably below 30% of total DoF, preferably above 10% of total DoF, and in the illustrated embodiment approximately 16% of the total DoF)
   Spine 60: 1 degree of freedom (preferably below 5% of total DoF, and in the illustrated embodiment approximately 1% of the total DoF)
   Pelvis 64: 1 degree of freedom (preferably below 5% of total DoF, and in the illustrated embodiment approximately 1% of the total DoF)
   Each Hip 70: 1 degree of freedom (preferably below 5% of total DoF, and in the illustrated embodiment approximately 1% of the total DoF)
   Each Upper Thigh 76: 2 degrees of freedom (preferably below 10% of total DoF, preferably above 2% of total DoF, and in the illustrated embodiment approximately 3% of the total DoF of the robot 1)
   Each Lower Thigh 80: 1 degree of freedom (preferably below 5% of total DoF, in the illustrated embodiment approximately 1% of the total DoF of the robot 1)
Lower Portion 4: 4 degrees of freedom (preferably below 10% of total DoF, preferably above 2% of total DoF, and approximately 6% of the total DoF)
   Each Shin 84: 1 degree of freedom (preferably below 5% of total DoF, and in the illustrated embodiment approximately 1% of the total DoF)
   Each Talus 88/Foot 92: 1 degree of freedom (preferably below 5% of total DoF, and in the illustrated embodiment approximately 1% of the total DoF)

The number and specific distribution of these degrees of freedom provide several significant advantages over conventional robots that lack such sophisticated kinematic arrangements. For example, positioning more than 50%, preferably more than 65%, and most preferably more than 75% of the total degrees of freedom in the upper portion 2 of the robot 1 allows said robot 1 to perform highly dexterous tasks that could not be performed without a substantial majority of the degrees of freedom being concentrated in this upper portion. These tasks may include precision assembly operations, delicate object manipulation, tool use, and complex hand gestures for communication. Additionally, minimizing the number of degrees of freedom within the central portion 3 enables the robot 1 to be designed with a larger internal torso volume, which allows for the inclusion of a larger battery pack and additional computing power, thereby improving performance and reliability. Finally, including less than 15% and preferably less than 10%, and/or approximately 6% of the total degrees of freedom within the lower portion 4 of the robot 1 beneficially minimizes the torque that is placed on the knees and hips during locomotion and manipulation tasks and allows the robot to minimize the time and number of steps for turning, which enables more humanlike movements and increases the speed at which certain tasks can be accomplished.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals that control actuator movements, process sensor data, and coordinate system-level behaviors. The architecture includes power distribution networks, control bus systems, and signal processing pathways that integrate the robot's various subsystems. As illustrated comprehensively in the additional FIGS. herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are for performing such a diverse array of generalized tasks in human-centric environments.

i. Actuators

The robot 1 is equipped with a sophisticated actuation system comprising a total of forty-two actuators 1.2.4 in the illustrative embodiment that collectively provide the mechanical power for all robot movements. These actuators are the primary means of generating motion throughout the robot's structure and converting electrical energy into mechanical work. Thirty of these actuators, designated as (J1) through (J16), are strategically housed within the main structural components of the robot 1 to control the movement of its limbs and torso through precise angular positioning. The housing locations have been selected to optimize weight distribution, minimize moment arms, and maximize structural efficiency. In addition to these primary actuators, an aggregate of twelve specialized actuators are integrated within the hands 56 to provide fine motor control for grasping and manipulation tasks. Alternative embodiments may feature a different total number of actuators, for instance, a simplified model may have fewer actuators to reduce cost and complexity, while a more advanced model may include additional actuators for increased degrees of freedom, such as in the spine. The distribution of actuators may also be modified; for example, more actuators could be concentrated in the lower body to enhance locomotion capabilities over challenging terrain. The materials used for the actuator housings themselves may also be varied, including a wide range of alternatives selected for specific properties. These may include various lightweight metal alloys, such as aluminum alloys (e.g., 6061 or 7075 series), magnesium alloys, or titanium and its alloys (e.g., Ti-6Al-4V), which offer excellent strength-to-weight ratios and corrosion resistance. Furthermore, advanced composite materials may be employed, such as carbon-fiber-reinforced polymer (CFRP), aramid-fiber-reinforced polymer (AFRP), or glass-fiber-reinforced polymer (GFRP), to significantly reduce overall weight and inertia without compromising strength or stiffness characteristics. For applications demanding extreme stiffness or thermal stability, metal matrix composites (MMCs) or high-performance polymers like polyether ether ketone (PEEK) may also be utilized to maintain dimensional stability under varying thermal loads.

The following summary table, Table 2, provides a detailed inventory of the thirty primary actuators 1.2.4, identified by their reference names and numbers from (J1) to (J16). For each actuator, the table specifies the quantity, a descriptive name used for consistency within this disclosure, common informal names, and the associated axis of rotation within the high-level configuration of the illustrative embodiment of the robot 1. It is important to note that the specific actuators located within each hand 56 are not individually itemized in this particular table.

TABLE 2

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm | upper arm x, upper arm roll | A₃ |
| | | twist | | |
| (J4) 374 | 2 | elbow | arm z, arm yaw, lower humerus | A₄ |
| (J5) 468 | 2 | lower arm | lower arm x, lower arm roll | A₅ |
| | | twist | | |
| (J6) 484 | 2 | wrist flex | wrist/hand y, wrist/hand pitch, | A₆ |
| | | | flick | |
| (J7) 520 | 2 | wrist pivot | wrist/hand z, wrist/hand yaw, | A₇ |
| | | | wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward | A₁₁ |
| | | | kick | |
| (J12) 768 | 2 | hip roll | hip x, hip/leg roll, sideways | A₁₂ |
| | | | kick | |
| (J13) 782 | 2 | leg twist | hip z, hip/leg yaw | A₁₃ |
| (J14) 820 | 2 | knee | lower thigh, lower leg y, lower | A₁₄ |
| | | | leg pitch, rear kick | |
| (J15) 860 | 2 | foot flex | foot y, foot pitch, or first ankle | A₁₅ |
| (J16) 900 | 2 | foot roll | talus, foot roll, foot x, second | A₁₆ |
| | | | ankle | |

It should be understood that in other embodiments of the robot 1, some of these systems, assemblies, components, and/or parts may be omitted, combined, or replaced with alternative systems, assemblies, components, and/or parts to suit different functional requirements or design philosophies. For example, the head may be simplified to a single-axis twist joint, or the wrist may be given an additional degree of freedom to improve manipulation dexterity.

A substantial majority of the actuators 1.2.4, specifically about thirty of the forty-two actuators, which constitutes approximately 66.7% of the total, are configured for direct drive. In this configuration, the actuator is not connected to a drive linkage; instead, it directly drives the associated part of the robot 1, offering a simplified and robust mechanical interface. Conversely, in the illustrative embodiment of the robot 1, fourteen of the forty-two actuators 1.2.4, representing about 33.3% of the total (which is more than 10%, and preferably more than 25%), are coupled to a drive linkage. An alternative arrangement may involve a greater use of drive linkages, such as tendon-driven systems, particularly in the arms and legs, to move the mass of the actuators closer to the robot's core, thereby reducing limb inertia and allowing for faster and more energy-efficient movements.

These drive linkages are predominantly utilized for an aggregate total of twelve rotary actuators contained within both hands 56. The use of drive linkages in this context serves two critical functions. First, it allows the fingers and thumb to be under-actuated. This design principle means that the digits can retain the ability to flex, curl, or passively rotate around an object, conforming to its shape without requiring an individual actuator to control each joint or degree of freedom, which significantly reduces complexity and weight in the hands. Alternative approaches to under-actuation may involve the use of compliant joints made from flexible materials or the integration of differential gear systems within the hand. Second, a drive linkage is employed to allow the foot 92 to pivot around an axis that is located well forward (e.g., more than 10% of the overall length of the foot) of the center of the drive linkage, enhancing stability and dynamic response during locomotion. A modification to this design may involve an adjustable pivot point, allowing the robot to change its foot mechanics for different terrains or gaits.

The robot 1 exclusively uses electric actuators, a design choice that purposefully omits manual, hydraulic, cable-based, or pneumatic actuators. This exclusive reliance on electric actuation provides numerous advantages. The use of electric actuators significantly reduces the complexity of assembly and maintenance, lowers the overall weight and cost of the system, and increases both durability and safety, particularly in considerations related to operating the robot 1 within or around humans where the risks associated with high-pressure hydraulic fluids or pneumatic lines are eliminated. However, for certain specialized applications requiring extremely high force density, a hybrid system may be contemplated. For instance, a future modification may incorporate compact hydraulic or pneumatic actuators for specific high-load joints, such as the hips or knees, while retaining electric actuators for the rest of the body.

### 1. Peak Actuator Torque

As noted previously, the forty-two rotary actuators can be classified into seven primary types based on their performance characteristics and torque output capabilities, as detailed in the table below. Each row in the table indicates a momentary peak torque range in Newton-meters (N-m) for a specific actuator type that has been validated through extensive testing. This commonality between the actuators is a deliberate design choice that beneficially reduces manufacturing costs through economies of scale, shortens assembly time through standardized procedures, decreases the number of unique parts that are required for inventory and repair, streamlines debugging time through consistent behavior patterns, and increases the overall modularity and serviceability of the robot 1. In fact, this commonality may extend to the point that all of these actuator types have an identical arrangement of internal components, differing only in aspects that affect their torque output, such as motor windings with different turn counts or gear reduction ratios optimized for specific load profiles. In an alternative embodiment, core components may be interchangeable across different actuator types. For example, the motor, gearbox, and encoder could be separate modules that can be combined in various configurations to create the desired torque and speed characteristics for any given joint, further enhancing serviceability and upgradeability.

TABLE 3

| Actuator | | Momentary Peak | Preferred Momentary |
|---|---|---|---|
| Type | Actuator | Torque (N-m) | Peak Torque (N-m) |
| 1, G | (J11) 720 | 204-307 | 230-281 |
| | (J14) 820 | | |
| 2, E | (J1) 190 | 125-188 | 141-172 |
| | (J12) 768 | | |
| | (J13) 782 | | |
| | (J15) 860 | | |
| 3, C | (J9) 680 | 204-307 | 230-281 |
| | (J10) 620 | | |
| 4, B | (J2) 280 | 81-122 | 91-112 |
| | (J3) 320 | | |
| | (J4) 374 | | |
| 5, D | (J16) 900 | 45-68 | 51-62 |
| 6, A | (J5) 468 | 15-22 | 17-20 |
| | (J6) 484 | | |
| | (J7) 520 | | |
| | (J8.1) 120 | | |
| | (J8.2) 140 | | |
| 7, F | Hands | 2.5-6 | 4-5.5 |

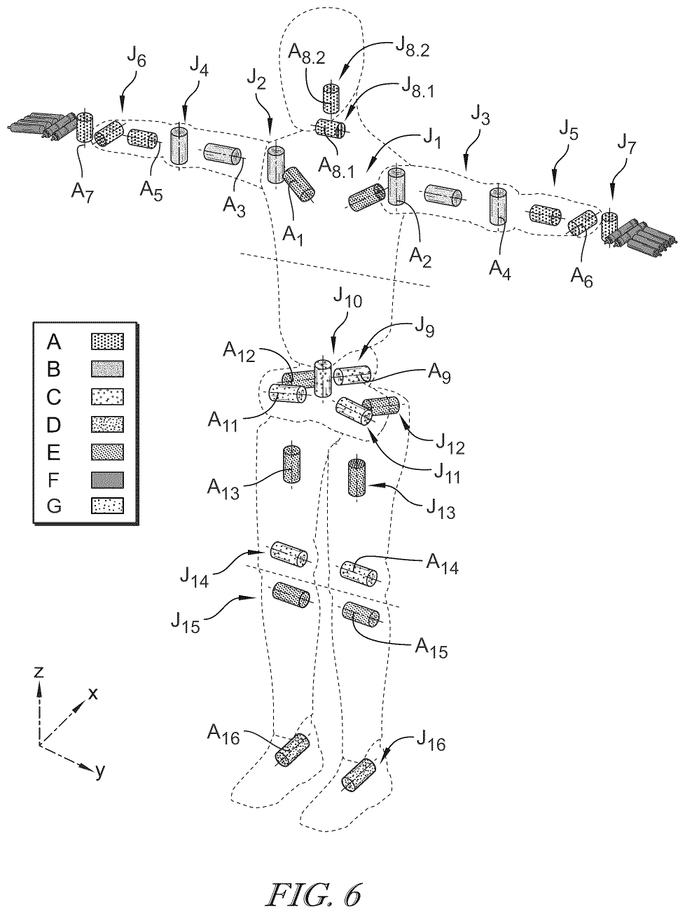

Based on these functional differences, the identified actuator torque types can be strategically distributed within the humanoid robot 1, as shown in FIG. 6 and described in the table below. This distribution ensures that joints requiring higher torque, such as those in the legs and torso, are equipped with appropriately powerful actuators, while joints requiring less torque, such as those in the arms and head, use more lightweight and efficient actuators. Alternative distribution strategies may be employed based on the intended application of the robot. A robot designed for heavy lifting, for example, may utilize a higher proportion of Type G and C actuators in its upper body.

TABLE 4

| | | Number of Actuators |
|---|---|---|
| | Total Momentary Peak | Having the Momentary |
| Type | Torque (N-m) Values | Peak Torque (N-m) |
| Upper Portion | 4 | 100% of: |
| | | type A (total of 8) |
| | | type B (total of 6) |
| | | type F (total of 12) |
| | | 25% of: |
| | | type E (total of 2) |
| Central Portion | 3 | 100% of: |
| | | type C (total of 2) |
| | | type G (total of 4) |
| | | 50% of |
| | | type E (total of 4) |
| Lower Portion | 2 | 100% of: |
| | | type D (total of 2) |
| | | 25% of: |
| | | type E (total of 2) |

In addition to the above general arrangement, the following types are distributed as shown below:
Upper Portion 2:
   Head and Neck Assembly: 2 Type A's (preferably below 8% of total NOA, preferably above 3% of total NOA, and in the illustrated embodiment approximately 5% of the total NOA); (preferably below 40% of total type A's, preferably above 20% of total type A's, and in the illustrated embodiment approximately 25% of the total type A's)
   Each Arm Actuator: 2 Type E's (preferably below 7% of total number of actuators (NOA), preferably above 3% of total NOA, and in the illustrated embodiment approximately 5% of the total NOA); (preferably below 40% of total type E's, preferably above 20% of total type E's, and in the illustrated embodiment approximately 25% of the total type E's)
   Each Arm Assembly 5:
      Each Upper Portion of the Arm Assembly: 3 Type B's (preferably below 10% of total NOA, preferably above 6% of total NOA, and in the illustrated embodiment approximately 7% of the total NOA); (preferably below 65% of total type B's, preferably above 45% of total type B's, and in the illustrated embodiment approximately 50% of the total type B's)
         Each Shoulder 26: 1 Type B (preferably below 3% of total NOA, preferably above 1% of total NOA, and in the illustrated embodiment approximately 2% of the total NOA); (preferably below 20% of total type B's, preferably above 10% of total type B's, and in the illustrated embodiment approximately 17% of the total type B's)
         Each Upper Humerus 30: 1 Type B (preferably below 3% of total NOA, preferably above 1% of total NOA, and in the illustrated embodiment approximately 2% of the total NOA); (preferably below 20% of total type B's, preferably above 10% of total type B's, and in the illustrated embodiment approximately 17% of the total type B's)
         Each Elbow 39: 1 Type B (preferably below 3% of total NOA, preferably above 1% of total NOA, and in the illustrated embodiment approximately 2% of the total NOA); (preferably below 20% of total type B's, preferably above 10% of total type B's, and in the illustrated embodiment approximately 17% of the total type B's)
      Each Lower Portion of the Arm Assembly: 3 Type A's (preferably below 10% of total NOA, preferably above 6% of total NOA, and in the illustrated embodiment approximately 7% of the total NOA); (preferably below 45% of total type A's, preferably above 25% of total type A's, and in the illustrated embodiment approximately 38% of the total type A's)
         Each Lower Forearm 46: 1 Type A (preferably below 3% of total NOA, preferably above 1% of total NOA, and in the illustrated embodiment approximately 2% of the total NOA); (preferably below 25% of total type A's, preferably above 10% of total type A's, and in the illustrated embodiment approximately 13% of the total type A's)
         Each Wrist 50: 2 Type A's (preferably below 8% of total NOA, preferably above 3% of total NOA, and in the illustrated embodiment approximately 5% of the total NOA); (preferably below 40% of total type A's, preferably above 20% of total type A's, and in the illustrated embodiment approximately 25% of the total type A's)
   Each Hand 56: 6 Type F's (preferably below 20% of total NOA, preferably above 10% of total NOA, and in the illustrated embodiment approximately 14% of the total NOA); (preferably below 65% of total type F's, preferably above 45% of total type F's, and in the illustrated embodiment approximately 50% of the total type F's)
      Each Finger: 1 Type F (preferably below 3% of total NOA, preferably above 1% of total NOA, and in the illustrated embodiment approximately 2% of the total NOA); (preferably below 10% of total type F's, preferably above 5% of total type F's, and in the illustrated embodiment approximately 8% of the total type F's)
      Thumb: 2 Type F's (preferably below 7% of total number of actuators (NOA, preferably above 3% of total NOA, and in the illustrated embodiment approximately 5% of the total NOA); (preferably below 20% of total type F's, preferably above 10% of total type F's, and in the illustrated embodiment approximately 17% of the total type F's)
Central Portion 3:
   Spine 60: 1 Type C (preferably below 3% of total NOA, preferably above 1% of total NOA, and in the illustrated embodiment approximately 2% of the total NOA); (preferably below 65% of total type C's, preferably above 45% of total type C's, and in the illustrated embodiment approximately 50% of the total type C's)
   Pelvis 64: 1 Type C (preferably below 3% of total NOA, preferably above 1% of total NOA, and in the illustrated embodiment approximately 2% of the total NOA); (preferably below 65% of total type C's, preferably above 45% of total type C's, and in the illustrated embodiment approximately 50% of the total type C's)
   Each Hip 70: 1 Type G (preferably below 3% of total NOA, preferably above 1% of total NOA, and in the illustrated embodiment approximately 2% of the total NOA); (preferably below 40% of total type G's, preferably above 20% of total type G's, and in the illustrated embodiment approximately 25% of the total type G's)
   Each Upper Thigh 76: 2 Type E's (preferably below 7% of total number of actuators (NOA, preferably above 3% of total NOA, and in the illustrated embodiment approximately 5% of the total NOA); (preferably below 40% of total type E's, preferably above 20% of total type E's, and in the illustrated embodiment approximately 25% of the total type E's)
   Each Lower Thigh 80: 1 Type G (preferably below 3% of total NOA, preferably above 1% of total NOA, and in the illustrated embodiment approximately 2% of the total NOA); (preferably below 40% of total type G's, preferably above 20% of total type G's, and in the illustrated embodiment approximately 25% of the total type G's)
Lower Portion 4:
   Each Shin 84: 1 Type E (preferably below 3% of total NOA, preferably above 1% of total NOA, and in the illustrated embodiment approximately 2% of the total NOA); (preferably below 25% of total type E's, preferably above 10% of total type E's, and in the illustrated embodiment approximately 13% of the total type E's)
   Each Talus 88/Foot 92: 1 Type D (preferably below 3% of total NOA, preferably above 1% of total NOA, and in the illustrated embodiment approximately 2% of the total NOA); (preferably below 65% of total type D's, preferably above 45% of total type D's, and in the illustrated embodiment approximately 50% of the total type D's)

### 2. Peak Motor Torque

It should be noted that the actuators (J1)-(J16) may incorporate a wide range and/or combination of advanced motor types. The selection of a particular motor is based on a detailed analysis of specific performance requirements such as torque density measured in Newton-meters per kilogram, response time measured in milliseconds, energy efficiency expressed as a percentage, and operational lifespan measured in millions of cycles. These motor types may include, but are not limited to, brushless direct current (BLDC) motors, which are often favored for their high efficiency and reliability demonstrated through mean time between failures; stepper motors, which offer precise open-loop position control with angular resolution; servo motors, which provide high-performance closed-loop control; coreless direct current (DC) motors; synchronous alternating current (AC) motors; asynchronous induction motors; linear motors for non-rotary motion; piezoelectric motors; direct-drive motors; switched reluctance motors; permanent magnet synchronous motors (PMSMs); axial flux motors, which can offer very high torque density in a flat profile; and hybrid stepper motors.

The selection of these motor types may depend on a careful balancing of various operational constraints. These constraints include, but are not limited to, strict weight limitations, which directly affect the robot's agility and energy consumption; power consumption considerations; the required degree of positional accuracy; and the surrounding environmental conditions, such as thermal dissipation capacity and resistance to electromagnetic interference, vibration, and shock. For instance, piezoelectric motors, which operate on a different physical principle, may be preferred for applications demanding extremely high precision with minimal backlash and no magnetic field generation, such as when operating near sensitive scientific instruments. Conversely, direct-drive motors may be selected to eliminate the need for mechanical transmission components entirely, thereby reducing system complexity, removing a source of backlash and friction, and increasing overall reliability and force fidelity, which is particularly advantageous for applications requiring safe and direct physical interaction with humans.

The designer may select a motor that either uses or does not use rare-earth permanent magnets. The motors that use rare-earth permanent magnet compositions may include neodymium-iron-boron (NdFeB) alloys, samarium-cobalt (SmCo) magnets, aluminum-nickel-cobalt (alnico) magnets, cobalt-platinum (CoPt) alloys, iron-nitride (FeN) magnets, strontium ferrite magnets, and amorphous metal-based magnets. Alternatively, motors that do not use rare-earth permanent magnets, such as synchronous reluctance motors or ferrite-magnet-assisted synchronous reluctance motors, may be selected to mitigate the high cost and supply chain volatility. For example, PMSMs may be particularly suited for the leg joints (J11, J14) due to their high torque density and efficiency. In contrast, coreless DC motors, which have a very low rotor inertia, may be chosen for the hands (56).

Furthermore, the motor windings may be constructed using high-conductivity copper wire, which may be treated with advanced insulation materials such as ceramic-based or polyimide coatings rated for high temperatures (e.g., Class H insulation). These coatings serve to provide enhanced thermal stability, superior electrical insulation, and reduced power losses that arise from resistive heating during operation. An alternative conductor material may be aluminum, which offers a lower weight at the cost of lower conductivity, or even carbon nanotube yarns in future improvements for an exceptional strength-to-weight ratio. The use of high-performance winding topologies, such as concentrated, distributed, or fractional-slot concentrated winding configurations, may further optimize motor performance. For example, distributed windings can produce a more sinusoidal back-EMF, leading to smoother operation and lower torque ripple, while concentrated windings can reduce the length of end-turns, thereby decreasing copper losses and improving thermal performance.

Additionally, the actuator design may incorporate advanced cooling mechanisms to manage thermal loads, which is critical for sustained high-performance operation. Such mechanisms, including liquid cooling channels integrated directly into the motor housing stator using micro-channel technology, the use of phase-change materials that absorb latent heat during thermal spikes, integrated heat pipes, thermoelectric coolers (Peltier devices), or forced air convection systems, can significantly enhance thermal dissipation and prevent overheating. An improvement may be to integrate thermal sensors, such as thermistors or thermocouples, directly into the motor windings for more accurate real-time temperature monitoring, allowing the control system to safely push the motor closer to its thermal limits. To further improve energy efficiency, electromagnetic shielding materials and precision winding techniques, such as orthocyclic winding to maximize the copper fill factor, may be implemented to minimize parasitic eddy currents and hysteresis losses. In certain high-frequency applications, multi-stranded litz wire configurations can be employed to reduce skin effect and proximity effect losses, optimizing high-frequency current conduction, particularly in motors subjected to the high-speed switching of modern power electronics.

TABLE 5

| Motor | | Momentary Peak | Preferred Momentary |
|---|---|---|---|
| Type | Actuator | Torque (N-m) | Peak Torque (N-m) |
| 1, H | (J9) 680 | 3.44-5.16 | 3.87-4.73 |
| | (J10) 620 | | |
| | (J11) 720 | | |
| | (J14) 820 | | |
| 2, I | (J1) 190 | 2.24-3.36 | 2.52-3.08 |
| | (J12) 768 | | |
| | (J13) 782 | | |
| | (J15) 860 | | |
| 3, J | (J2) 280 | 1.16-1.74 | 1.31-1.60 |
| | (J3) 320 | | |
| | (J4) 374 | | |
| 4, K | (J16) 900 | 0.7-1.06 | 0.79-0.97 |
| 5, L | (J5) 468 | 0.24-0.36 | 0.27-0.33 |
| | (J6) 484 | | |
| | (J7) 520 | | |
| | (J8.1) 120 | | |
| | (J8.2) 140 | | |
| 6, M | Hands | 0.08-0.12 | 0.09-0.11 |

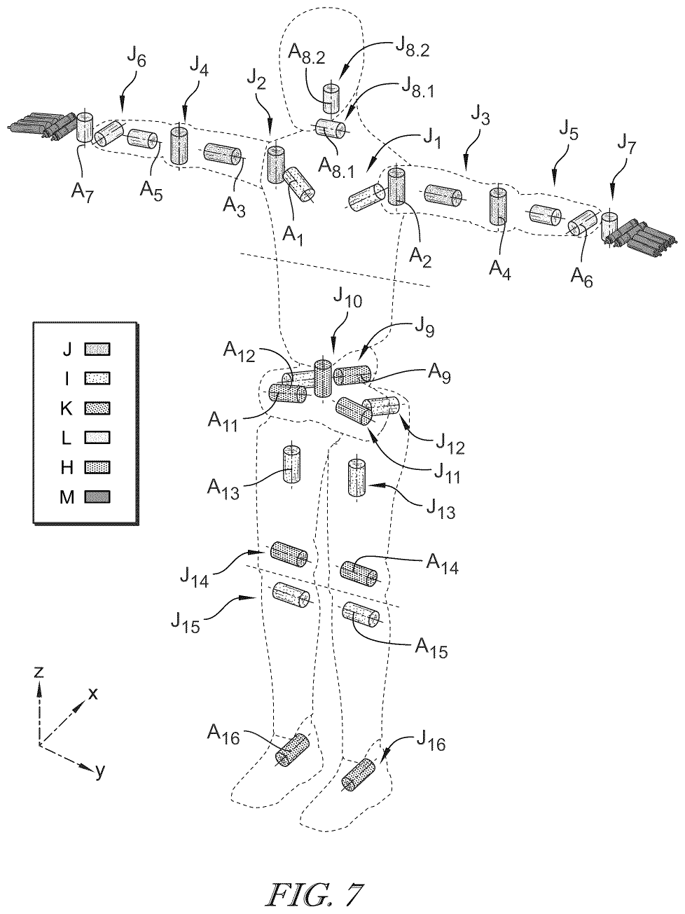

Based on these distinctions in motor torque, the identified motor types can be distributed throughout the humanoid robot 1, as depicted in FIG. 7 and detailed in the table below. This strategic placement ensures that motor capabilities are matched to the dynamic requirements of each part of the robot.

TABLE 6

| | Total Momentary | Number of Actuators |
|---|---|---|
| | Peak Torque | Having the Momentary |
| Type | (N-m) Values | Peak Torque (N-m) |
| Upper Portion | 4 | 100% of: |
| | | type L (total of 8) |
| | | type J (total of 6) |
| | | type M (total of 12) |
| | | 25% of: |
| | | type I (total of 2) |
| Central Portion | 2 | 100% of: |
| | | type H (total of 6) |
| | | 50% of |
| | | type I (total of 4) |
| Lower Portion | 2 | 100% of: |
| | | type K (total of 2) |
| | | 25% of: |
| | | type I (total of 2) |

In addition to the above general arrangement, the following types are distributed as shown below:
Upper Portion 2:
   Head and Neck Assembly: 2 Type L's (preferably below 8% of total NOA, preferably above 3% of total NOA, and in the illustrated embodiment approximately 5% of the total NOA); (preferably below 40% of total type L's, preferably above 20% of total type L's, and in the illustrated embodiment approximately 25% of the total type L's)
   Each Arm Actuator: 2 Type I's (preferably below 7% of total number of actuators (NOA), preferably above 3% of total NOA, and in the illustrated embodiment approximately 5% of the total NOA); (preferably below 40% of total type I's, preferably above 20% of total type I's, and in the illustrated embodiment approximately 25% of the total type I's)
   Each Arm Assembly 5:
      Each Upper Portion of the Arm Assembly: 3 Type J's (preferably below 10% of total NOA, preferably above 6% of total NOA, and in the illustrated embodiment approximately 7% of the total NOA); (preferably below 65% of total type J's, preferably above 45% of total type J's, and in the illustrated embodiment approximately 50% of the total type J's)
         Each Shoulder 26: 1 Type J (preferably below 3% of total NOA, preferably above 1% of total NOA, and in the illustrated embodiment approximately 2% of the total NOA); (preferably below 20% of total type J's, preferably above 10% of total type J's, and in the illustrated embodiment approximately 17% of the total type J's)
         Each Upper Humerus 30: 1 Type J (preferably below 3% of total NOA, preferably above 1% of total NOA, and in the illustrated embodiment approximately 2% of the total NOA); (preferably below 20% of total type J's, preferably above 10% of total type J's, and in the illustrated embodiment approximately 17% of the total type J's)
         Each Elbow 39: 1 Type J (preferably below 3% of total NOA, preferably above 1% of total NOA, and in the illustrated embodiment approximately 2% of the total NOA); (preferably below 20% of total type J's, preferably above 10% of total type J's, and in the illustrated embodiment approximately 17% of the total type J's)
      Each Lower Portion of the Arm Assembly: 3 Type L's (preferably below 10% of total NOA, preferably above 6% of total NOA, and in the illustrated embodiment approximately 7% of the total NOA); (preferably below 45% of total type L's, preferably above 25% of total type L's, and in the illustrated embodiment approximately 38% of the total type L's)
         Each Lower Forearm 46: 1 Type L (preferably below 3% of total NOA, preferably above 1% of total NOA, and in the illustrated embodiment approximately 2% of the total NOA); (preferably below 25% of total type L's, preferably above 10% of total type L's, and in the illustrated embodiment approximately 13% of the total type L's)
         Each Wrist 50: 2 Type L's (preferably below 8% of total NOA, preferably above 3% of total NOA, and in the illustrated embodiment approximately 5% of the total NOA); (preferably below 40% of total type L's, preferably above 20% of total type L's, and in the illustrated embodiment approximately 25% of the total type L's)
   Each Hand 56: 6 Type M's (preferably below 20% of total NOA, preferably above 10% of total NOA, and in the illustrated embodiment approximately 14% of the total NOA); (preferably below 65% of total type M's, preferably above 45% of total type M's, and in the illustrated embodiment approximately 50% of the total type M's)
      Each Finger: 1 Type M (preferably below 3% of total NOA, preferably above 1% of total NOA, and in the illustrated embodiment approximately 2% of the total NOA); (preferably below 10% of total type M's, preferably above 5% of total type M's, and in the illustrated embodiment approximately 8% of the total type M's)
      Thumb: 2 Type M's (preferably below 7% of total number of actuators (NOA, preferably above 3% of total NOA, and in the illustrated embodiment approximately 5% of the total NOA); (preferably below 20% of total type M's, preferably above 10% of total type M's, and in the illustrated embodiment approximately 17% of the total type M's)
Central Portion 3:
   Spine 60: 1 Type H (preferably below 3% of total NOA, preferably above 1% of total NOA, and in the illustrated embodiment approximately 2% of the total NOA); (preferably below 20% of total type H's, preferably above 10% of total type H's, and in the illustrated embodiment approximately 17% of the total type H's)
   Pelvis 64: 1 Type H (preferably below 3% of total NOA, preferably above 1% of total NOA, and in the illustrated embodiment approximately 2% of the total NOA); (preferably below 20% of total type H's, preferably above 10% of total type H's, and in the illustrated embodiment approximately 17% of the total type H's)
   Each Hip 70: 1 Type H (preferably below 3% of total NOA, preferably above 1% of total NOA, and in the illustrated embodiment approximately 2% of the total NOA); (preferably below 20% of total type H's, preferably above 10% of total type H's, and in the illustrated embodiment approximately 17% of the total type H's)
   Each Upper Thigh 76: 2 Type I's (preferably below 7% of total number of actuators (NOA, preferably above 3% of total NOA, and in the illustrated embodiment approximately 5% of the total NOA); (preferably below 40% of total type I's, preferably above 20% of total type I's, and in the illustrated embodiment approximately 25% of the total type I's)
   Each Lower Thigh 80: 1 Type H (preferably below 3% of total NOA, preferably above 1% of total NOA, and in the illustrated embodiment approximately 2% of the total NOA); (preferably below 20% of total type H's, preferably above 10% of total type H's, and in the illustrated embodiment approximately 17% of the total type H's)
Lower Portion 4:
   Each Shin 84: 1 Type I (preferably below 3% of total NOA, preferably above 1% of total NOA, and in the illustrated embodiment approximately 2% of the total NOA); (preferably below 25% of total type I's, preferably above 10% of total type I's, and in the illustrated embodiment approximately 13% of the total type I's)
   Each Talus 88/Foot 92: 1 Type K (preferably below 3% of total NOA, preferably above 1% of total NOA, and in the illustrated embodiment approximately 2% of the total NOA); (preferably below 65% of total type K's, preferably above 45% of total type D's, and in the illustrated embodiment approximately 50% of the total type K's)

### 3. Gearbox Reduction Ratio

The motors may be coupled with various high-reduction gear mechanisms that are specifically designed for precision with backlash less than 0.1 degrees, high torque amplification ratios exceeding 100:1, and robust load handling capabilities supporting radial loads exceeding 1000 Newtons. These mechanisms may include, but are not limited to, strain wave gearboxes (e.g., harmonic drives), cycloidal reducers, planetary gearboxes, bevel gear systems, worm gears, parallel shaft helical gear mechanisms; spur gear assemblies; crossed helical gear systems; double-enveloping worm gears; herringbone gears; hypoid gears; rack-and-pinion systems for linear motion; bevel hypoid gears; epicyclic gear trains; and differential gear systems. Each actuator incorporated in the humanoid robot 1 is equipped with a gearbox that facilitates a specific gear reduction ratio, thereby optimizing the balance between output torque and output speed for its designated joint. A potential improvement may be the inclusion of a multi-speed gearbox or a continuously variable transmission (CVT) in certain key joints, such as the knee (J14) or elbow (J4). This would provide a much wider dynamic range, enabling both rapid, low-torque movements for repositioning a limb and slow, high-torque movements for lifting heavy objects, all from a single actuator, thereby increasing the robot's versatility and energy efficiency across different tasks.

The selection of a specific gearbox type is determined based on a careful consideration and weighting of factors such as the peak and continuous torque requirements of the joint, the need for backlash minimization for positional accuracy, overall transmission efficiency which impacts battery life, strict weight and volume constraints, and long-term durability and reliability considerations. The gear reduction ratio achieved by each gearbox can vary significantly depending on the design and functional requirements of the humanoid robot 1. The possible reduction ratios may include, but are not limited to, 2:1, 3:1, 5:1, 7:1, 10:1, 15:1, 20:1, 30:1, 40:1, 50:1, 80:1, 100:1, 120:1, 150:1, 200:1, 300:1, 400:1, and 500:1. These various ratios enable precise control over the robot's kinematic chain by allowing a critical balance of speed and torque as required by different joints for different tasks. For example, a high ratio like 200:1 may be ideal for a wrist pivot joint (J7) requiring fine, precise movements, while a lower ratio like 50:1 may be better suited for a hip flex joint (J11) that needs to produce faster leg swings during walking or running.

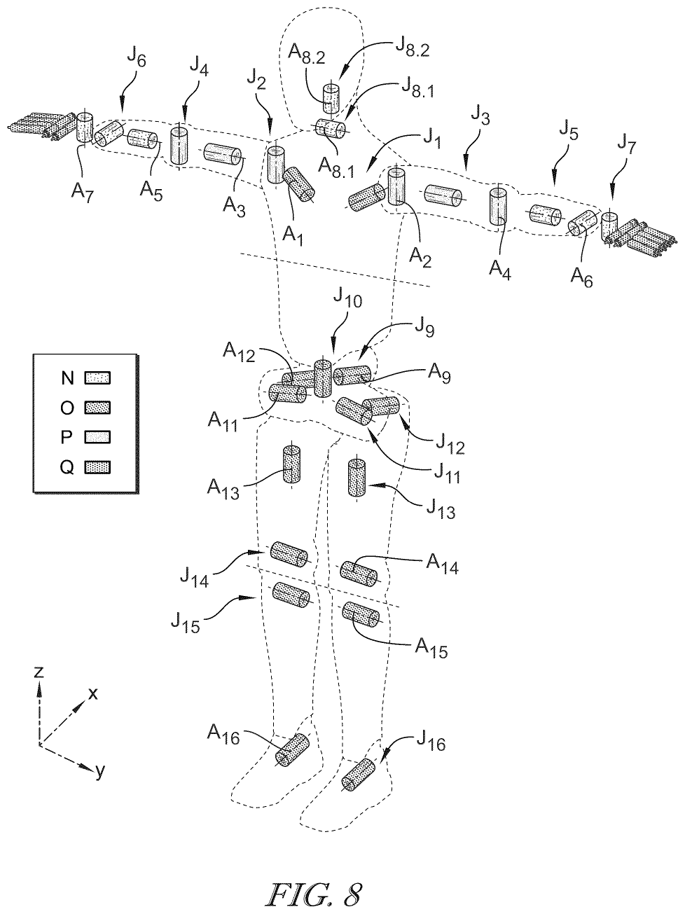

In particular, the illustrative embodiment of the humanoid robot 1 incorporates a structured selection of five distinct gear reduction values. These values are strategically implemented across the various actuation points to optimize the overall mechanical performance of the system. FIG. 8 illustrates the specific gear reduction values applied to the different joints within the humanoid robot 1, a configuration that ensures an effective balance between power transmission efficiency, actuator responsiveness, and mechanical longevity. These specific values have been selected based on comprehensive analysis, including dynamic simulations of the robot performing various tasks and finite element analysis (FEA) of the gear components under the anticipated dynamic and static load conditions for each joint. This rigorous analysis ensures that each gearbox is robust enough for its intended use and contributes to the enhanced operational stability, accuracy, and energy efficiency of the entire humanoid system.

Additionally, some implementations may incorporate custom gear profiles, with specific mathematical definitions such as modified involute or cycloidal tooth profiles, that are computationally optimized for higher torque transfer efficiency, further backlash reduction, improved lubrication characteristics, and/or acoustic noise minimization. Furthermore, said actuators may include safety and control features such as brakes or clutches. These components may be of various types, including electromagnetic power-off brakes, which are inherently fail-safe as they engage when power is lost; permanent magnet brakes for compact holding torque; or mechanical wrap-spring clutches that can engage or disengage rapidly. These features can protect the gearbox and motor from excessive shock loads and/or allow for power to be removed from the actuators without causing the robot 1 to collapse or fall to the ground. In some embodiments, the actuators may also include internal limiting features, such as a robust mechanical hard-stop, which acts as a final physical failsafe, complemented by adjustable software-based limits that provide the primary means of preventing damage from over-rotation during normal operation.

The utilization of multiple, distinct gear reduction ratios across the humanoid robot 1 allows for the implementation of highly adaptive and energy-efficient control strategies. This enables the generation of smooth and precise motion profiles that are tailored for a wide range of different operational scenarios, from delicate manipulation to dynamic locomotion. By integrating a diverse set of reduction ratios, the system can effectively manage the varying torque and speed requirements of complex movements. This enhances the humanoid robot's capability to perform sophisticated actions while maintaining structural integrity, improving the system's dynamic response, and minimizing mechanical wear on gear teeth and bearings over its operational lifetime, ultimately leading to a more robust and reliable robotic platform.

TABLE 7

| Motor | | Reduction | Preferred Reduction |
|---|---|---|---|
| Type | Actuator | Ratios | Ratios |
| 1, O | (J1) 190 | 150:1-20:1 | 100:1-50:1 |
| | (J9) 680 | | |
| | (J10) 620 | | |
| | (J11) 720 | | |
| | (J12) 768 | | |
| | (J13) 782 | | |
| | (J14) 820 | | |
| | (J15) 860 | | |
| | (J16) 900 | | |
| 2, P | (J2) 280 | 100:1-1:1 | 80:1-20:1 |
| | (J3) 320 | | |
| | (J4) 374 | | |
| 3, N | (J5) 468 | 300:1-50:1 | 125:1-80:1 |
| | (J6) 484 | | |
| | (J7) 520 | | |
| | (J8.1) 120 | | |
| | (J8.2) 140 | | |
| 4, Q | Hands | NA | NA |

Based on these differences in reduction ratios, the identified ratio types can be distributed within the humanoid robot 1, as shown in FIG. 8 and detailed in the table below, to provide tailored performance across the robot's body.

TABLE 8

| | Total Reduction | Number of Actuators Having |
|---|---|---|
| Type | Ratio Values | the Reduction Ratio |
| Upper Portion | 4 | 100% of: |
| | | type N (total of 8) |
| | | type Q (total of 12) |
| | | type P (total of 6) |
| | | 12.5% of: |
| | | type O (total of 2) |
| Central Portion | 1 | 62.5% of: |
| | | type O (total of 10) |
| Lower Portion | 1 | 25% of: |
| | | type O (total of 4) |

In addition to the above general arrangement, the following types are distributed as shown below:
Upper Portion 2:
   Head and Neck Assembly: 2 Type N's (preferably below 800 of total NOA, preferably above 3% of total NOA, and in the illustrated embodiment approximately 5% of the total NOA); (preferably below 400% of total type N's, preferably above 200% of total type N's, and in the illustrated embodiment approximately 250% of the total type N's)
   Each Arm Actuator: 2 Type O's (preferably below 700 of total number of actuators (NOA), preferably above 3% of total NOA, and in the illustrated embodiment approximately 5% of the total NOA); (preferably below 25% of total type O's, preferably above 10% of total type O's, and in the illustrated embodiment approximately 13% of the total type O's)
   Each Arm Assembly 5:
      Each Upper Portion of the Arm Assembly: 3 Type P's (preferably below 10% of total NOA, preferably above 6% of total NOA, and in the illustrated embodiment approximately 7% of the total NOA); (preferably below 65% of total type P's, preferably above 45% of total type P's, and in the illustrated embodiment approximately 50% of the total type P's)
         Each Shoulder 26: 1 Type P (preferably below 3% of total NOA, preferably above 1% of total NOA, and in the illustrated embodiment approximately 2% of the total NOA); (preferably below 20% of total type J's, preferably above 10% of total type P's, and in the illustrated embodiment approximately 17% of the total type P's)
         Each Upper Humerus 30: 1 Type P (preferably below 3% of total NOA, preferably above 1% of total NOA, and in the illustrated embodiment approximately 2% of the total NOA); (preferably below 20% of total type P's, preferably above 10% of total type P's, and in the illustrated embodiment approximately 17% of the total type P's)
         Each Elbow 39: 1 Type P (preferably below 3% of total NOA, preferably above 1% of total NOA, and in the illustrated embodiment approximately 2% of the total NOA); (preferably below 20% of total type P's, preferably above 10% of total type P's, and in the illustrated embodiment approximately 17% of the total type P's)
      Each Lower Portion of the Arm Assembly: 3 Type N's (preferably below 10% of total NOA, preferably above 6% of total NOA, and in the illustrated embodiment approximately 7% of the total NOA); (preferably below 45% of total type N's, preferably above 25% of total type N's, and in the illustrated embodiment approximately 38% of the total type N's)
         Each Lower Forearm 46: 1 Type N (preferably below 3% of total NOA, preferably above 1% of total NOA, and in the illustrated embodiment approximately 2% of the total NOA); (preferably below 25% of total type N's, preferably above 10% of total type N's, and in the illustrated embodiment approximately 13% of the total type N's)
         Each Wrist 50: 2 Type N's (preferably below 8% of total NOA, preferably above 3% of total NOA, and in the illustrated embodiment approximately 5% of the total NOA); (preferably below 40% of total type N's, preferably above 20% of total type N's, and in the illustrated embodiment approximately 25% of the total type N's)
   Each Hand 56: 6 Type Q's (preferably below 20% of total NOA, preferably above 10% of total NOA, and in the illustrated embodiment approximately 14% of the total NOA); (preferably below 65% of total type Q's, preferably above 45% of total type Q's, and in the illustrated embodiment approximately 50% of the total type Q's)
      Each Finger: 1 Type Q (preferably below 3% of total NOA, preferably above 1% of total NOA, and in the illustrated embodiment approximately 2% of the total NOA); (preferably below 10% of total type Q's, preferably above 5% of total type Q's, and in the illustrated embodiment approximately 8% of the total type Q's)
      Thumb: 2 Type Q's (preferably below 7% of total number of actuators (NOA, preferably above 3% of total NOA, and in the illustrated embodiment approximately 5% of the total NOA); (preferably below 20% of total type Q's, preferably above 10% of total type Q's, and in the illustrated embodiment approximately 17% of the total type Q's)
Central Portion 3:
   Spine 60: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)
   Pelvis 64: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)
   Each Hip 70: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)
   Each Upper Thigh 76: 2 Type O's (preferably below 7% of total number of actuators (NOA, preferably above 3% of total NOA, and in the illustrated embodiment approximately 5% of the total NOA); (preferably below 25% of total type O's, preferably above 10% of total type O's, and in the illustrated embodiment approximately 13% of the total type O's)
   Each Lower Thigh 80: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)
Lower Portion 4:
   Each Shin 84: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)
   Each Talus 88/Foot 92: 1 Type O (preferably below 3% of total NOA, preferably above 1% of total NOA, and in the illustrated embodiment approximately 2% of the total NOA); (preferably below 10% of total type O's, preferably above 5% of total type O's, and in the illustrated embodiment approximately 6% of the total type O's)

### 4. Gearbox Type and Encoder Type

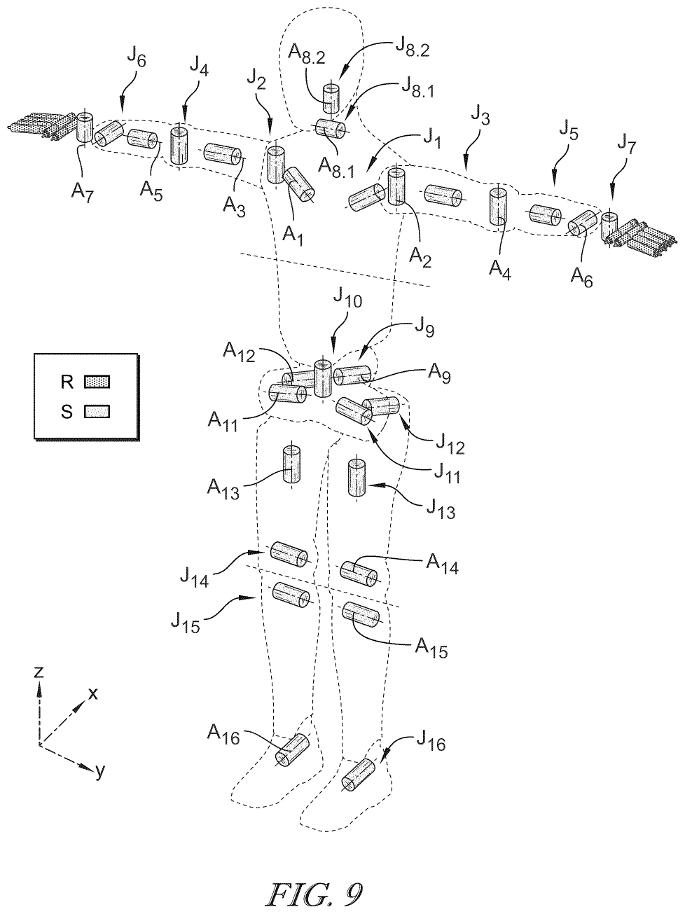

FIG. 9 provides a schematic representation that identifies commonalities between the actuator's gearbox type and encoder type across the robot 1, demonstrating the systematic approach to component selection and standardization. The motors may be coupled with various high-reduction gear mechanisms, which are designed for precision, significant torque amplification, and high load-handling capabilities. These may include, but are not limited to, strain wave gearboxes (e.g., Harmonic drives), cycloidal reducers, and planetary gearboxes. Other potential options include bevel gear systems, worm gears, parallel shaft helical gear mechanisms, spur gear assemblies, crossed helical gear systems, double-enveloping worm gears, herringbone gears, hypoid gears, rack-and-pinion systems, bevel hypoid gears, epicyclic gear trains, and differential gear systems.

Additionally, in some implementations, custom gear profiles may be engineered with non-standard tooth geometries that optimize contact patterns and load distribution. These may include asymmetric teeth that provide different characteristics for forward and reverse operation, logarithmic spiral designs that maintain constant pressure angles, or parabolic curvature that minimizes stress concentrations, all designed to optimize torque transfer efficiency above 95%, reduce backlash below detectable levels, improve wear resistance through optimized sliding velocities, and minimize operational noise below 60 decibels. These advanced profiles may be generated using sophisticated computational modeling techniques, such as finite element analysis (FEA) for stress distribution evaluation and topology optimization for material efficiency, to achieve optimal mechanical performance under a variety of load conditions. Advanced materials such as case-hardened alloy steels, ceramics, composite polymers, titanium alloys, or high-performance thermoplastics may be used for the gears to enhance durability, reduce weight, and improve efficiency. In some implementations, hybrid composite-metallic gears may be utilized to balance strength and flexibility, thereby reducing overall system inertia by up to 30%. Surface treatments, including ion nitriding to depths of 0.5 millimeters, carburizing, diamond-like carbon (DLC) coatings with thickness of 2-5 micrometers, boronizing, tungsten carbide coatings, and plasma-assisted chemical vapor deposition (PACVD), may further improve wear resistance by factors of 5-10, reduce friction losses by up to 50%, and enhance corrosion protection. Additionally, low-friction coatings, such as molybdenum disulfide (MoS₂) with friction coefficients below 0.1 or polytetrafluoroethylene (PTFE)-based coatings, may be applied to improve energy efficiency.

To achieve exceptional positional accuracy with errors less than 0.01 degrees and ensure reliable operation over millions of cycles, each motor may be equipped with advanced encoders that provide real-time position feedback. These encoders may be of an absolute type that maintains position information without power or incremental type that provides relative position changes, and may employ various sensing methodologies, such as optical encoders with resolutions exceeding 20 bits, magnetic encoders, and capacitive encoders. Other options include inductive encoders, resistive encoders, piezoelectric encoders, Hall-effect encoders, potentiometric encoders, and ultrasonic encoders. An improved configuration may employ a dual-encoder setup for critical joints, with one encoder on the motor shaft (pre-gearbox) and a second encoder on the actuator output (post-gearbox). This allows for direct measurement of the output position with accuracy better than 0.001 radians, enabling the control system to actively compensate for gearbox backlash and torsional effects.

To complement positional data and enable force-controlled operation, the actuator assembly may further incorporate integrated torque sensors with measurement ranges from 0.1 to 500 Newton-meters. These may include strain gauge sensors, piezoresistive sensors, magnetoelastic sensors, capacitive torque sensors, fiber-optic sensors, and rotary transformers. Alternative sensor configurations may include ultrasonic torque sensors, quartz-based piezoelectric torque sensors, and eddy current torque sensors. In some implementations, multi-axis torque sensors may be employed to detect torque components in multiple directions with crosstalk below 1%, enabling more comprehensive force feedback for safe human-robot interaction. Moreover, advanced hybrid sensor designs may integrate multiple sensing modalities to enhance sensitivity to micro-Newton-meter levels and provide redundancy for safety-rated applications, and smart self-calibrating torque sensors may be incorporated to improve long-term reliability through drift compensation.

Additionally, or alternatively, the actuators may include current sensors to monitor motor performance with sampling rates exceeding 10 kHz and optimize control strategies for efficiency improvements of up to 15%. These may comprise Hall-effect sensors with isolation voltages above 2500V, shunt resistors with temperature coefficients below 50 ppm/° C., fluxgate sensors with resolution below 1 milliampere, Rogowski coils for high-frequency current measurement, and magnetoresistive sensors with bandwidth exceeding 1 MHz. Furthermore, for enhanced control and environmental adaptability, the system may integrate micro-electromechanical systems (MEMS) gyroscopes with drift rates below 10 degrees per hour and/or accelerometers with noise densities below 100 μg/√Hz. These sensors provide real-time feedback on orientation with accuracy better than 0.1 degrees, angular velocity with resolution below 0.01 degrees per second, and linear acceleration with sensitivity to 0.001 g, enabling the humanoid robot to maintain balance on surfaces with inclinations up to 30 degrees and execute smooth movements with jerk limitations below 100 m/s³. Advanced sensor fusion algorithms, such as extended Kalman filters with update rates exceeding 1 kHz, may be employed to combine data from these multiple sources (e.g., encoders, IMUs, torque sensors) to produce a more accurate and robust estimate of the robot's state with latencies below 1 millisecond.

In this particular embodiment, the humanoid robot 1 simplifies these choices and includes three types of gearboxes and encoders. FIG. 9 shows that the humanoid robot 1 includes the following three types of gearboxes and encoders, though only two are utilized in the provided table.

TABLE 9

| Motor | | |
|---|---|---|
| Type | Actuator | Type |
| 1, R | (J1) 190 | 1 Strain Wave Gearboxes |
| | (J2) 280 | |
| | (J3) 320 | |
| | (J4) 374 | |
| | (J5) 468 | |
| | (J6) 484 | |
| | (J7) 520 | |
| | (J8.1) 120 | |
| | (J8.2) 140 | |
| | (J9) 680 | |
| | (J10) 620 | |
| | (J11) 720 | |
| | (J12) 768 | |
| | (J13) 782 | |
| | (J14) 820 | |
| | (J15) 860 | |
| | (J16) 900 | |
| 2, S | Hands | 2 Planetary Gearboxes |

Based on these design choices, the gearbox and encoder types can be distributed within the humanoid robot 1, as shown in FIG. 9 and described in the table below. This distribution reflects the different mechanical requirements of the body's various portions.

TABLE 10

| | Total Types of | Number of Actuators |
|---|---|---|
| | Gearboxes and | Having the Gearbox |
| Type | Encoders | and Encoder Types |
| Upper Portion | 2 | 100% of: |
| | | type S (total of 12) |
| | | 53% of: |
| | | type R (total of 16) |
| Central Portion | 1 | 33% of: |
| | | type R (total of 10) |
| Lower Portion | 1 | 13% of: |
| | | type R (total of 4) |

In addition to the above general arrangement, the following types are distributed as shown below:
Upper Portion 2:
   Head and Neck Assembly: 2 Type R's (preferably below 7% of total number of actuators (NOA), preferably above 3% of total NOA, and in the illustrated embodiment approximately 5% of the total NOA); (preferably below 10% of total type R's, preferably above 5% of total type R's, and in the illustrated embodiment approximately 6% of the total type R's)
   Each Arm Actuator: 2 Type R's (preferably below 7% of total number of actuators (NOA), preferably above 3% of total NOA, and in the illustrated embodiment approximately 5% of the total NOA); (preferably below 10% of total type R's, preferably above 5% of total type R's, and in the illustrated embodiment approximately 6% of the total type R's)
   Each Arm Assembly 5:
      Each Upper Portion of the Arm Assembly: 3 Type R's (preferably below 10% of total NOA, preferably above 6% of total NOA, and in the illustrated embodiment approximately 7% of the total NOA); (preferably below 15% of total type R's, preferably above 7% of total type R's, and in the illustrated embodiment approximately 10% of the total type R's)
         Each Shoulder 26: 1 Type R (preferably below 3% of total NOA, preferably above 1% of total NOA, and in the illustrated embodiment approximately 2% of the total NOA); (preferably below 5% of total type R's, preferably above 1% of total type R's, and in the illustrated embodiment approximately 3% of the total type R's)
         Each Upper Humerus 30: 1 Type R (preferably below 3% of total NOA, preferably above 1% of total NOA, and in the illustrated embodiment approximately 2% of the total NOA); (preferably below 5% of total type R's, preferably above 1% of total type R's, and in the illustrated embodiment approximately 3% of the total type R's)
         Each Elbow 39: 1 Type R (preferably below 3% of total NOA, preferably above 1% of total NOA, and in the illustrated embodiment approximately 2% of the total NOA); (preferably below 5% of total type R's, preferably above 1% of total type R's, and in the illustrated embodiment approximately 3% of the total type R's)
      Each Lower Portion of the Arm Assembly: 3 Type R's (preferably below 10% of total NOA, preferably above 6% of total NOA, and in the illustrated embodiment approximately 7% of the total NOA); (preferably below 15% of total type R's, preferably above 7% of total type R's, and in the illustrated embodiment approximately 10% of the total type R's)
         Each Lower Forearm 46: 1 Type R (preferably below 3% of total NOA, preferably above 1% of total NOA, and in the illustrated embodiment approximately 2% of the total NOA); (preferably below 5% of total type R's, preferably above 1% of total type R's, and in the illustrated embodiment approximately 3% of the total type R's)
         Each Wrist 50: 2 Type R's (preferably below 7% of total number of actuators (NOA), preferably above 3% of total NOA, and in the illustrated embodiment approximately 5% of the total NOA); (preferably below 10% of total type R's, preferably above 5% of total type R's, and in the illustrated embodiment approximately 6% of the total type R's)
   Hand 56: 6 Type S's (preferably below 20% of total NOA, preferably above 10% of total NOA, and in the illustrated embodiment approximately 14% of the total NOA); (preferably below 65% of total type S's, preferably above 45% of total type S's, and in the illustrated embodiment approximately 50% of the total type S's)
      Each Finger: 1 Type S (preferably below 3% of total NOA, preferably above 1% of total NOA, and in the illustrated embodiment approximately 2% of the total NOA); (preferably below 10% of total type S's, preferably above 5% of total type S's, and in the illustrated embodiment approximately 8% of the total type S's)
      Thumb: 2 Type S's (preferably below 7% of total number of actuators (NOA, preferably above 3% of total NOA, and in the illustrated embodiment approximately 5% of the total NOA); (preferably below 20% of total type S's, preferably above 10% of total type S's, and in the illustrated embodiment approximately 17% of the total type S's)
Central Portion 3:
   Spine 60: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)
   Pelvis 64: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)
   Each Hip 70: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)
   Each Upper Thigh 76: 2 Type R's (preferably below 7% of total number of actuators (NOA, preferably above 3% of total NOA, and in the illustrated embodiment approximately 5% of the total NOA); (preferably below 10% of total type R's, preferably above 5% of total type R's, and in the illustrated embodiment approximately 6% of the total type R's)
   Each Lower Thigh 80: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)
Lower Portion 4:
   Each Shin 84: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)
   Each Talus 88/Foot 92: 1 Type R (preferably below 3% of total NOA, preferably above 1% of total NOA, and in the illustrated embodiment approximately 2% of the total NOA); (preferably below 10% of total type R's, preferably above 5% of total type R's, and in the illustrated embodiment approximately 8% of the total type R's)

### 5. Inclusion of a Cross-Roller Bearing

The actuators, or the output of the actuators, may include bearing housings constructed using advanced materials selected for their high strength-to-weight ratio exceeding 150 MPa/(g/cm³) and durability demonstrated through fatigue life exceeding 10 million cycles. These materials may include carbon-fiber-reinforced polymers (CFRPs) with fiber volume fractions above 60%, fiberglass-reinforced polymers (FRPs) with impact resistance exceeding 50 kJ/m², various metal alloys including aerospace-grade aluminum and titanium, polyetheretherketone (PEEK) with continuous use temperatures above 250° C., thermoplastic composites with in-situ consolidation capabilities, and ultra-high-molecular-weight polyethylene (UHMWPE) with wear rates below 0.1 mm per million cycles. For example, CFRP housings may be chosen for their exceptional stiffness-to-weight ratio exceeding 200 GPa/(g/cm³), which helps to reduce limb inertia by up to 40% and allow for faster, more dynamic movements with accelerations exceeding 10 g. Additionally, the manufacturing processes for these materials, such as filament winding or automated fiber placement with in-situ compaction, allow for precise control over fiber orientation within ±1 degree, which further optimizes the mechanical performance and structural integrity of the housings under multi-axial loading conditions.

The bearings themselves can be fabricated from, include, or be processed using a variety of high-performance materials that provide exceptional wear resistance and load capacity. These may include high-grade steel alloys (e.g., AISI 52100 with carbon content of 0.98-1.10%, M50 for high-temperature operation above 315° C., or 440C stainless steel with corrosion resistance in marine environments), high-performance nickel-based superalloys (e.g., Inconel 718 with yield strength above 1000 MPa or Hastelloy for chemical resistance), cobalt-based alloys (e.g., Stellite with hot hardness retention above 500° C.), advanced ceramics (e.g., alumina with hardness above 2000 HV or zirconia-based composites with fracture toughness exceeding 10 MPa·m½), and polymer matrix composites reinforced with carbon or aramid fibers providing specific strength above 500 kN·m/kg. These materials may also benefit from advanced heat treatments (e.g., vacuum hardening at 10 Pa or cryogenic treatment at −196° C.), surface engineering processes (e.g., ion implantation to depths of 100 nanometers or physical vapor deposition with coating adhesion above 60 N), or specialized low-friction coatings with coefficients below 0.05. To further optimize performance, the rolling elements of the bearings may be composed of advanced ceramic materials (e.g., silicon nitride with elastic modulus of 310 GPa, tungsten carbide with hardness above 2800 HV, or zirconia with density 40% lower than steel), sapphire with hardness of 2000 HV, or composite materials that combine ceramic particles with metal or polymer matrices for tailored properties. In another embodiment, the assembly may incorporate alternative bearing arrangements, such as a pair of angular contact ball bearings with contact angles optimized between 15 and 40 degrees or a combination of radial and thrust bearings with load ratings exceeding design requirements by factors of 2 or more, instead of a single cross-roller bearing, depending on the specific load profile with radial loads up to 10 kN and stiffness requirements exceeding 100 N/μm of the joint. Additionally, spherical roller bearings for self-alignment, tapered roller bearings for combined loads, needle roller bearings for compact designs, magnetic bearings for frictionless operation, or hybrid configurations thereof may be used based on application demands.

Cutting-edge manufacturing techniques, including additive manufacturing methods like selective laser melting (SLM) with layer resolution below 20 micrometers, could be employed to create complex, monolithic bearing geometries. These custom geometries may integrate advanced features such as internal cooling channels, built-in lubrication reservoirs, or textured surfaces with dimple patterns designed to enhance lubrication retention and minimize wear. This could also allow for the creation of integrated bearing and housing components, reducing part count and assembly complexity. The incorporation of such features allows for improved thermal management with temperature rises limited to 30° C. above ambient, reduced friction with coefficients below 0.002, and more consistent lubrication distribution across contact surfaces, even under challenging high-load operating conditions exceeding 5 kN. Additive manufacturing also enables the production of customized bearing designs with minimal material waste below 5%, aligning with sustainable and efficient manufacturing practices while achieving buy-to-fly ratios approaching 1:1.

In addition to additive manufacturing, other advanced processes like precision machining, laser hardening, or chemical vapor deposition (CVD) coatings may be applied to enhance the surface properties of the bearings. These techniques can improve wear resistance, reduce friction, and provide robust protection against corrosion, further extending the operational life of these components to exceed 20,000 hours. The integration of smart sensors, such as embedded strain gauges with resolution below 1 microstrain or fiber Bragg gratings with wavelength stability below 1 picometer, within the bearing housing is another potential enhancement, allowing for real-time monitoring of key parameters such as temperature with accuracy of ±0.1° C., vibration with frequency response to 10 kHz, and load with resolution below 0.1% of full scale. This data can be used for predictive maintenance algorithms employing machine learning techniques to anticipate maintenance needs with accuracy above 95% and prevent unexpected failures, ensuring optimal performance and reliability throughout the robot's operational lifetime.

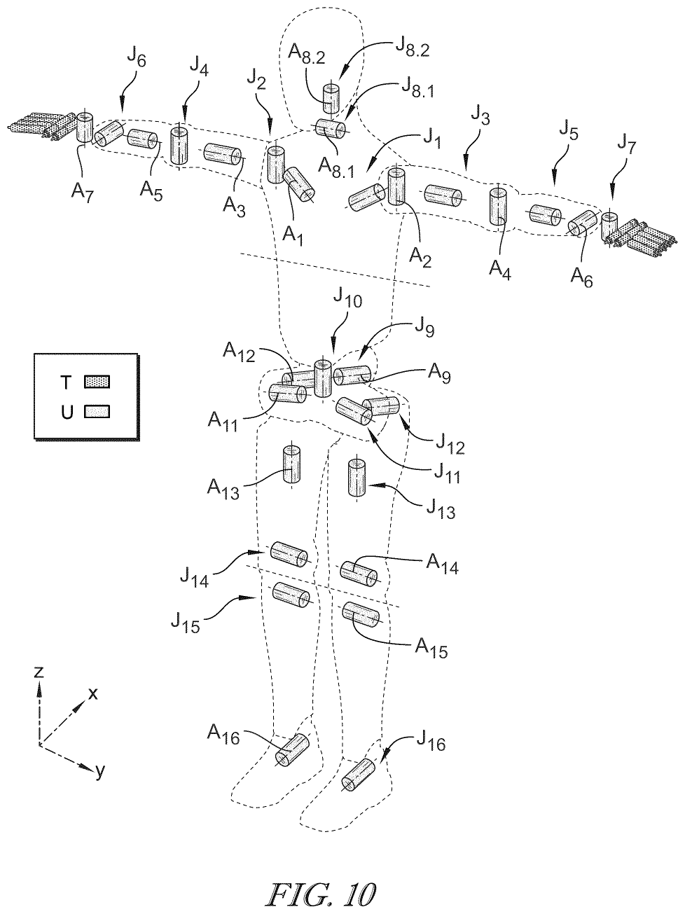

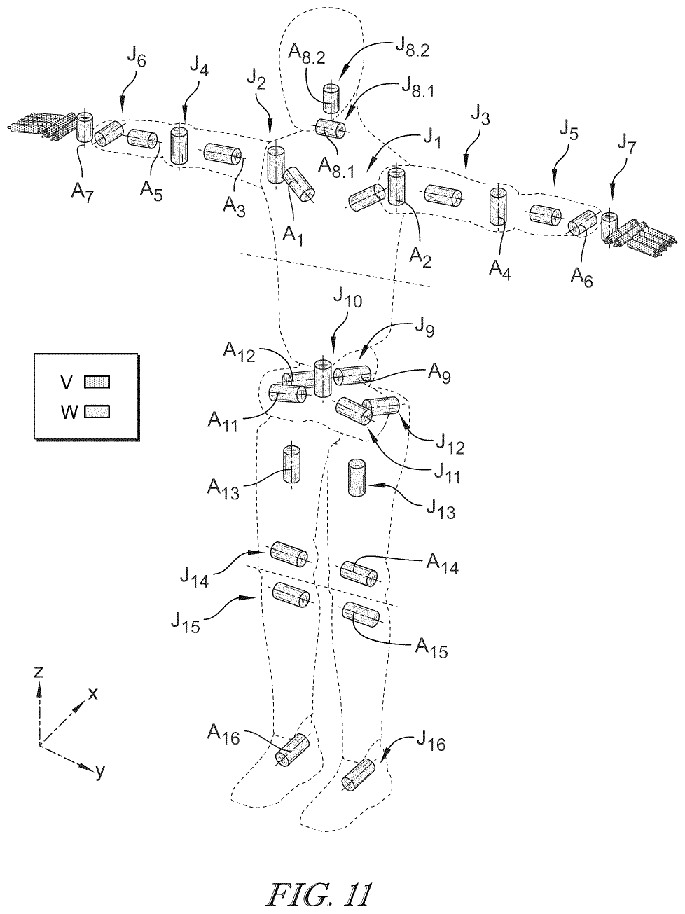

In the particular embodiment shown, the humanoid robot 1 includes actuators that either include or do not include a cross-roller bearing. FIG. 10 illustrates this binary configuration, where the choice is based on the load requirements of the specific joint.

TABLE 11

| Motor | | Including a Cross- |
|---|---|---|
| Type | Actuator | Roller Bearing |
| 1, T | (J1) 190 | 1 (Yes) |
| | (J2) 280 | |
| | (J3) 320 | |
| | (J4) 374 | |
| | (J5) 468 | |
| | (J6) 484 | |
| | (J7) 520 | |
| | (J8.1) 120 | |
| | (J8.2) 140 | |
| | (J9) 680 | |
| | (J10) 620 | |
| | (J11) 720 | |
| | (J12) 768 | |
| | (J13) 782 | |
| | (J14) 820 | |
| | (J15) 860 | |
| | (J16) 900 | |
| 2, U | Hands | 2 (No) |

Based on these differences, the use of cross-roller bearings can be distributed within the humanoid robot 1, as shown in FIG. 10 and described in the table below.

TABLE 12

| | Number of Actuators Having |
|---|---|
| Type | a Cross-Roller Bearing |
| Upper Portion | 100% of: |
| | type U (total of 12) |
| | 53% of: |
| | type T (total of 16) |
| Central Portion | 33% of: |
| | type T (total of 10) |
| Lower Portion | 13% of: |
| | type T (total of 4) |

In addition to the above general arrangement, the following types are distributed as shown below:
Upper Portion 2:
   Head and Neck Assembly: 2 Type T's (preferably below 7% of total number of actuators (NOA), preferably above 3% of total NOA, and in the illustrated embodiment approximately 5% of the total NOA); (preferably below 10% of total type T's, preferably above 5% of total type T's, and in the illustrated embodiment approximately 6% of the total type T's)
   Each Arm Actuator: 2 Type T's (preferably below 7% of total number of actuators (NOA), preferably above 3% of total NOA, and in the illustrated embodiment approximately 5% of the total NOA); (preferably below 10% of total type T's, preferably above 5% of total type T's, and in the illustrated embodiment approximately 6% of the total type T's)
   Each Arm Assembly 5:
      Each Upper Portion of the Arm Assembly: 3 Type T's (preferably below 10% of total NOA, preferably above 6% of total NOA, and in the illustrated embodiment approximately 7% of the total NOA); (preferably below 15% of total type T's, preferably above 7% of total type T's, and in the illustrated embodiment approximately 10% of the total type T's)
         Each Shoulder 26: 1 Type T (preferably below 3% of total NOA, preferably above 1% of total NOA, and in the illustrated embodiment approximately 2% of the total NOA); (preferably below 5% of total type T's, preferably above 1% of total type T's, and in the illustrated embodiment approximately 3% of the total type T's)
         Each Upper Humerus 30: 1 Type T (preferably below 3% of total NOA, preferably above 1% of total NOA, and in the illustrated embodiment approximately 2% of the total NOA); (preferably below 5% of total type T's, preferably above 1% of total type T's, and in the illustrated embodiment approximately 3% of the total type T's)
         Each Elbow 39: 1 Type T (preferably below 3% of total NOA, preferably above 1% of total NOA, and in the illustrated embodiment approximately 2% of the total NOA); (preferably below 5% of total type T's, preferably above 1% of total type T's, and in the illustrated embodiment approximately 3% of the total type T's)
      Each Lower Portion of the Arm Assembly: 3 Type T's (preferably below 10% of total NOA, preferably above 6% of total NOA, and in the illustrated embodiment approximately 7% of the total NOA); (preferably below 15% of total type T's, preferably above 7% of total type T's, and in the illustrated embodiment approximately 10% of the total type T's)
         Each Lower Forearm 46: 1 Type T (preferably below 3% of total NOA, preferably above 1% of total NOA, and in the illustrated embodiment approximately 2% of the total NOA); (preferably below 5% of total type T's, preferably above 1% of total type T's, and in the illustrated embodiment approximately 3% of the total type T's)
         Each Wrist 50: 2 Type T's (preferably below 7% of total number of actuators (NOA), preferably above 3% of total NOA, and in the illustrated embodiment approximately 5% of the total NOA); (preferably below 10% of total type T's, preferably above 5% of total type T's, and in the illustrated embodiment approximately 6% of the total type T's)
   Each Hand 56: 6 Type U's (preferably below 20% of total NOA, preferably above 10% of total NOA, and in the illustrated embodiment approximately 14% of the total NOA); (preferably below 65% of total type U's, preferably above 45% of total type U's, and in the illustrated embodiment approximately 50% of the total type U's)
      Each Finger: 1 Type U (preferably below 3% of total NOA, preferably above 1% of total NOA, and in the illustrated embodiment approximately 2% of the total NOA); (preferably below 10% of total type U's, preferably above 5% of total type U's, and in the illustrated embodiment approximately 8% of the total type U's)
      Thumb: 2 Type U's (preferably below 7% of total number of actuators (NOA, preferably above 3% of total NOA, and in the illustrated embodiment approximately 5% of the total NOA); (preferably below 20% of total type U's, preferably above 10% of total type U's, and in the illustrated embodiment approximately 17% of the total type U's)
Central Portion 3:
   Spine 60: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)
   Pelvis 64: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)
   Each Hip 70: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)
   Each Upper Thigh 76: 2 Type T's (preferably below 7% of total number of actuators (NOA, preferably above 3% of total NOA, and in the illustrated embodiment approximately 5% of the total NOA); (preferably below 10% of total type T's, preferably above 5% of total type T's, and in the illustrated embodiment approximately 7% of the total type T's)
   Each Lower Thigh 80: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)
Lower Portion 4:
   Each Shin 84: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)
   Each Talus 88/Foot 92: 1 Type T (preferably below 3% of total NOA, preferably above 1% of total NOA, and in the illustrated embodiment approximately 2% of the total NOA); (preferably below 10% of total type T's, preferably above 5% of total type T's, and in the illustrated embodiment approximately 8% of the total type T's)

### 6. Inclusion of Through-Bore Wire

A substantial majority of the electric actuators utilized in the robot 1 include a through-bore wiring architecture. In this configuration, essential wires or leads carrying power up to 48 volts and data signals up to 1 Gbps are passed directly through a designated region, which is typically the hollow center of the actuator with bore diameters ranging from 10 to 50 millimeters. Each actuator includes a printed circuit board (PCB) assembly with component densities exceeding 500 components per square decimeter, a design that facilitates the efficient passing of electrical current up to 30 amperes and control signals with latencies below 100 microseconds from one actuator to the next. The wire harness extends from the PCB assembly through connectors rated for 10,000 mating cycles, passes through a dedicated wire passage formed within the actuator's core with bend radius limitations above 5 times the cable diameter, and exits at the bottom of the actuator to connect to the PCB assembly of an adjacent actuator in the kinematic chain with connection resistance below 10 milliohms. This structured wiring configuration ensures efficient power distribution with losses below 2% and control signal transmission with low bit error rates while significantly reducing mechanical complexity by eliminating external cable runs and minimizing potential points of failure associated with external wiring.

The wire harness assembly itself consists of several key components: (i) a first connector designed to couple with a PCB assembly of an adjacent actuator, (ii) a connecting portion that is positioned within the robot's housing or exoskeleton rather than inside an actuator, (iii) an optional strain relief member to minimize mechanical stress on the connections during movement, (iv) a through-bore portion that is housed within the actuator's central bore receiver, and (v) a second connector with contact resistance below 5 milliohms that is secured to the actuator's own PCB assembly via a transfer connector employing spring-loaded contacts. In other embodiments, the above-described wire harness can be split into two separate harnesses, wherein: (i) one harness is coupled within the robot in a fixed, non-rotating manner, and (ii) the other harness with torsional flexibility exceeding ±720 degrees is coupled between two PCBs (an input and an output) and is specifically designed to rotate within the actuator through-bore without degradation. An alternative to this rotating harness may be the use of an electrical slip ring with contact resistance variation below 10 milliohms or optical slip ring with insertion loss below 1 dB to pass power up to 100 watts and data up to 10 Gbps through the rotating joint, which can offer greater durability and unlimited rotation capability.

Furthermore, the wire harness can incorporate additional protective layers, such as a braided shielding or specialized dielectric coatings with breakdown voltage above 1500V, and may use shielded twisted pairs with impedance matching to 100 ohms for data lines to enhance electrical insulation to withstand 2500V isolation and minimize electromagnetic interference (EMI) below −40 dB. In certain implementations, flexible printed circuit boards (FPCBs) with copper thickness of 35-70 micrometers or coiled wire configurations with pitch optimized for flexibility may be used within the through-bore to better accommodate dynamic motion with angular displacements up to ±180 degrees, thereby reducing mechanical stress below fatigue limits and fatigue on the wiring system demonstrated through 20 million cycle testing. The use of flexible conductors with reinforced sheathing rated for 300V enhances overall durability, which is especially beneficial in high-mobility robots requiring frequent and high-range articulation exceeding 100 degrees of their joints at angular velocities above 360 degrees per second.

The structured design of the through-bore wire harness serves multiple important functions: (i) it facilitates the seamless and reliable transfer of power and control signals between adjacent actuators, (ii) it ensures that no single, continuous wire extends across multiple degrees of freedom, which could otherwise lead to entanglement or wear, (iii) it eliminates the need to route wires around the external ends or peripheries of the actuators, simplifying the design, and (iv) it allows for highly modular integration, making it substantially easier to replace or upgrade individual actuator units without extensive rewiring. This entire arrangement reduces potential pinch points, enhances the mechanical reliability of the wiring system, and simplifies the overall packaging of the actuators within the robot's compact structure.

Alternative embodiments may include different wire configurations, such as integrating the electrical power wiring and control wires within the robot's structural shell or outer layers, for example, by laminating flexible printed circuits onto the internal frame. In such embodiments, each actuator would interface with this shell-based wiring using a single, consolidated wire group. Additionally, variations in the number of wire groups (ranging from one to ten) can be implemented to accommodate different design requirements, such as increased data bandwidth or power delivery. For example, a dual-wire configuration may be used to provide a redundant power supply or to implement fail-safe mechanisms. Additionally, actuators may incorporate micro-connectors, zero-insertion-force (ZIF) connectors, or magnetic coupling interfaces to further streamline the wiring architecture. A more advanced modification may involve wireless power transfer and wireless data communication between actuator modules, which would completely eliminate physical wiring across the joints.

In this particular embodiment, the humanoid robot 1 includes actuators that either include or do not include through-bore wiring. FIG. 11 shows the humanoid robot 1 and illustrates this binary configuration.

TABLE 13

| Motor | | |
|---|---|---|
| Type | Actuator | Type |
| 1, V | (J1) 190 | 1 (Yes) |
| | (J2) 280 | |
| | (J3) 320 | |
| | (J4) 374 | |
| | (J5) 468 | |
| | (J6) 484 | |
| | (J7) 520 | |
| | (J8.1) 120 | |
| | (J8.2) 140 | |
| | (J9) 680 | |
| | (J10) 620 | |
| | (J11) 720 | |
| | (J12) 768 | |
| | (J13) 782 | |
| | (J14) 820 | |
| | (J15) 860 | |
| | (J16) 900 | |
| 2, W | Hands | 2 (No) |

Based on these differences, the gearbox and encoder types can be distributed within the humanoid robot 1, as shown in FIG. 11 and described below:

TABLE 14

| | Number of Actuators Having |
|---|---|
| Type | the Through-Bore Wiring |
| Upper Portion | 100% of: |
| | type W (total of 12) |
| | 53% of: |
| | type V (total of 16) |
| Central Portion | 33% of: |
| | type V (total of 10) |
| Lower Portion | 13% of: |
| | type V (total of 4) |

In addition to the above general arrangement, the following types are distributed as shown below:
Upper Portion 2:
   Head and Neck Assembly: 2 Type V's (preferably below 7% of total number of actuators (NOA), preferably above 3% of total NOA, and in the illustrated embodiment approximately 5% of the total NOA); (preferably below 10% of total type V's, preferably above 5% of total type V's, and in the illustrated embodiment approximately 6% of the total type V's)
   Each Arm Actuator: 2 type V's (preferably below 7% of total number of actuators (NOA), preferably above 3% of total NOA, and in the illustrated embodiment approximately 5% of the total NOA); (preferably below 10% of total type V's, preferably above 5% of total type V's, and in the illustrated embodiment approximately 6% of the total type V's)
   Each Arm Assembly 5:
      Each Upper Portion of the Arm Assembly: 3 Type V's (preferably below 10% of total NOA, preferably above 6% of total NOA, and in the illustrated embodiment approximately 7% of the total NOA); (preferably below 15% of total type V's, preferably above 7% of total type V's, and in the illustrated embodiment approximately 10% of the total type V's)
         Each Shoulder 26: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
         Each Upper Humerus 30: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
         Each Elbow 39: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
      Each Lower Portion of the Arm Assembly: 3 Type V's (preferably below 10% of total NOA, preferably above 6% of total NOA, and in the illustrated embodiment approximately 7% of the total NOA); (preferably below 15% of total type V's, preferably above 7% of total type V's, and in the illustrated embodiment approximately 10% of the total type V's)
         Each Lower Forearm 46: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
         Each Wrist 50: 2 Type V's (preferably below 7% of total number of actuators (NOA), preferably above 3% of total NOA, and in the illustrated embodiment approximately 5% of the total NOA); (preferably below 10% of total type V's, preferably above 5% of total type V's, and in the illustrated embodiment approximately 6% of the total type V's)
   Each Hand 56: 6 Type W's (preferably below 20% of total NOA, preferably above 10% of total NOA, and in the illustrated embodiment approximately 14% of the total NOA); (preferably below 65% of total type W's, preferably above 45% of total type W's, and in the illustrated embodiment approximately 50% of the total type W's)
      Each Finger: 1 Type W (preferably below 3% of total NOA, preferably above 1% of total NOA, and in the illustrated embodiment approximately 2% of the total NOA); (preferably below 10% of total type W's, preferably above 5% of total type W's, and in the illustrated embodiment approximately 8% of the total type W's)
      Thumb: 2 Type W's (preferably below 7% of total number of actuators (NOA, preferably above 3% of total NOA, and in the illustrated embodiment approximately 5% of the total NOA); (preferably below 20% of total type W's, preferably above 10% of total type W's, and in the illustrated embodiment approximately 17% of the total type W's)
Central Portion 3:
   Spine 60: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
   Pelvis 64: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
   Each Hip 70: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
   Each Upper Thigh 76: 2 Type V's (preferably below 7% of total number of actuators (NOA, preferably above 3% of total NOA, and in the illustrated embodiment approximately 5% of the total NOA); (preferably below 10% of total Type V's, preferably above 5% of total Type V's, and in the illustrated embodiment approximately 6% of the total Type V's)
   Each Lower Thigh 80: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
Lower Portion 4:
   Each Shin 84: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
   Each Talus 88/Foot 92: 1 Type V (preferably below 3% of total NOA, preferably above 1% of total NOA, and in the illustrated embodiment approximately 2% of the total NOA); (preferably below 5% of total type V's, preferably above 1% of total type V's, and in the illustrated embodiment approximately 3% of the total type V's)
      ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features with thread specifications conforming to ISO standards designed to support systems in specific locations with positional accuracy within ±0.5 millimeters, structural features including ribs and gussets engineered to withstand operational loads exceeding 1000 Newtons, and internal and/or external features such as cable routing channels and connector mounting points that allow for interoperation between adjacent components and/or are formed to resemble human anatomical features. Some housings 1.2.2 additionally include one or more detachable shells secured with fasteners torqued to 2-5 Newton-meters that may overlay a casing to allow access to internal assemblies for maintenance operations or to complete the form of the component while maintaining ingress protection ratings of IP54 or higher.

The requirements of the housings 1.2.2 can vary in shape and form based on the individual structural or material requirements for each specific component, with some regions experiencing loads exceeding 2000 Newtons while others experience primarily torsional loads below 50 Newton-meters. While it may be desirable to utilize a particular material for all housings 1.2.2 to create a consistent exterior appearance with surface roughness below Ra 1.6 micrometers, fabrication may be complicated by specific structural or operational needs at different locations that demand varying material properties. It may not be advantageous to utilize the same materials in different housings 1.2.2 that experience different load requirements ranging from compression loads of 5000 Newtons to tensile loads of 2000 Newtons. Various materials may be preferred for a specific housing 1.2.2 based on properties such as strength exceeding 200 MPa, toughness above 20 MJ/m³, elasticity with Young's modulus between 1 and 200 GPa, weight with densities below 5 g/cm³, and conductivity either below 10⁻¹⁴ S/m for insulators or above 10⁶ S/m for conductors. Similarly, the complexity of some housing 1.2.2 designs with features smaller than 1 millimeter may be better suited for one type of manufacturing process, such as CNC machining with tolerances of ±0.01 millimeters, die casting for production volumes above 10,000 units, injection molding with cycle times below 60 seconds, or composite fabrication with fiber volume fractions above 50%, over another. Because there is a desire or need to use different materials within different regions based on thermal expansion coefficients and/or use materials that do not have a consistent exterior appearance due to varying surface treatments, the illustrative embodiment robot 1 includes exterior coverings of the exterior covering assembly 1.2.16 that are designed to at least partially hide the housings 1.2.2 under a textile exterior layer with thickness between 0.5 and 3 millimeters that can be easily swapped in less than 10 minutes if damaged, serve to protect internal components from dust particles smaller than 100 micrometers and debris, are designed to fit the form of the robot 1 without substantial wrinkling defined as surface deviations below 5 millimeters, and/or allow for venting with airflow rates exceeding 10 liters per minute or address thermal considerations at specified locations where heat dissipation exceeds 50 watts.

The exterior coverings may have a multi-layered assembly with total thickness ranging from 2 to 15 millimeters, which may include: (i) an energy-absorbing material with compression set below 10% that is coupled to the coupling layer through adhesive bonds with peel strength exceeding 50 N/cm, (ii) a coupling layer (e.g., plastic or polymer based) with flexural modulus between 100 and 3000 MPa, wherein the coupling layer facilitates attachment to, or attachment at, a housing 1.2.2 through mechanical fasteners or adhesive bonding, and/or (iii) an exterior coverings material (e.g., a textile) with tear strength exceeding 100 Newtons. Alternatively, the multi-layered assembly may omit the coupling layer for direct attachment applications, the energy-absorbing material where impact protection is not a concern, and/or exterior covering material where the coupling layer provides adequate surface properties. In each case, the movement of the nearby joint with angular velocities up to 360 degrees per second may cause one housing 1.2.2 to impact or compress the energy absorbing layer with forces up to 200 Newtons instead of another housing 1.2.2, thereby mitigating or eliminating structural stress or load on either housing 1.2.2 and/or the respective actuator 1.2.4 while limiting peak deceleration to below 50 g. Additionally, the energy attenuation members help to reduce pinch points to gaps larger than 8 millimeters, and/or allow for a more human-like appearance with surface contours matching human anatomy within 10 millimeters.

### 1. Energy Attenuation Assembly

The energy attenuation assembly may be composed of a plurality of integrated or removable members with densities ranging from 30 to 500 kg/m³, such as pads with thickness from 5 to 50 millimeters, panels with surface areas from 50 to 500 cm², or bumpers with impact absorption capacities exceeding 10 Joules, that are attached to housings 1.2.2 of the robot 1 through mechanical fasteners, adhesive bonding with bond strength above 2 MPa, or are positioned within the external covers using retention features. The housings 1.2.2 and/or the energy attenuation members may include attachment features such as snap-fit connections with retention forces above 20 Newtons, bayonet mounts with angular engagement of 45 degrees, or hook-and-loop fasteners with shear strength above 70 N/cm² that are configured to receive these energy attenuation members with positional tolerance within ±1 millimeter. In some embodiments, they are attached directly to a particular exterior side of a housing 1.2.2 using pressure-sensitive adhesives with 180-degree peel strength above 20 N/cm, while in other embodiments, they may surround an exterior of a housing 1.2.2 with coverage exceeding 80% of the surface area or be attached to or retained by the exterior coverings as described above using mechanical interlocking features.

The disclosed robot 1 includes a torso energy attenuation member with compression resistance of 50-200 kPa, elbow energy attenuation members with thickness varying from 10 millimeters at the joint center to 25 millimeters at the periphery, and leg energy attenuation members with dual-density construction featuring soft outer layers of 30 kg/m³ and firm inner layers of 100 kg/m³. Additionally, energy attenuation members may be included at the hip with coverage area exceeding 200 cm², shin with impact resistance exceeding 20 Joules, and/or foot with compression set below 5% after 100,000 cycles. Some or all energy attenuation members may also be omitted based on application requirements and safety assessments. Energy attenuation members can be configured to enhance or alter the shape of the robot 1 without adding substantial weight defined as less than 5% of total robot mass and to provide a deformable structure with energy absorption properties exceeding 80% efficiency to protect underlying components from impacts up to 100 Joules.

The energy attenuation members can be made from a wide variety of materials with specific energy absorption ranging from 1 to 50 kJ/kg, including: (i) polymers, such as polyethylene foam (PE Foam) with densities from 20 to 200 kg/m³, ethylene vinyl acetate (EVA) foam with compression set below 10%, polyurethane foam (including Memory Foam with recovery time below 5 seconds and Open-cell Polyurethane Foam with air permeability above 10 cfm); (ii) rubber foams with resilience above 40%; (iii) natural foams including latex with elongation above 500%; (iv) engineered foams with controlled cell structures having cell sizes from 0.1 to 5 millimeters; (v) composite and hybrid materials combining multiple foam types; (vi) expanded polystyrene (EPS) with compressive strength from 70 to 700 kPa; (vii) expanded polypropylene (EPP); (viii) Koroyd®; (ix) D3O®; (x) Poron® XRD; (xi) thermoplastic elastomers (TPE) with Shore A hardness from 30 to 90 or thermoplastic polyurethane (TPU) with tensile strength above 30 MPa; (xii) any other material known to one of skill in the art that accomplishes the desired energy absorption characteristics with efficiency above 70%; (xiii) any combination of the above in multilayer or gradient configurations. Furthermore, the energy-absorbing material may alternatively or additionally include other structures of said materials fabricated through controlled manufacturing processes, wherein said structures may include lattices with relative densities from 5% to 50% and/or repeating units with characteristic dimensions from 1 to 20 millimeters, such as a cube with edge connectivity, sphere with optimal packing density, cylinder with aspect ratios from 0.5 to 2, cone with apex angles from 30 to 120 degrees, pyramid with triangular or square base, torus with major-to-minor radius ratios from 2 to 10, prism with polygonal cross-sections, tetrahedron with regular faces, dodecahedron with pentagonal faces, octahedron with triangular faces, icosahedron with twenty faces, ellipsoid with aspect ratios from 1 to 5, paraboloid with focal lengths from 10 to 100 millimeters, cuboid with orthogonal faces, or hexahedron with parallel faces. It should be understood that the repeating unit or lattice cell may be contained in a specific region with dimensions from 10 to 200 millimeters or may propagate throughout the entire energy attenuation member with unit cell variations below 5%. Additionally, the energy attenuation members and/or the assembly may have varying properties, such as thickness ranging from 5 to 50 millimeters, density from 30 to 500 kg/m³, C/D ratio from 0.2 to 0.8, and stiffness from 10 to 1000 N/mm. This variation may be arranged in a gradient manner with property changes of 10-20% per centimeter, wherein the energy-absorbing materials transition from softer regions with modulus below 1 MPa to firmer layers with modulus above 10 MPa or regions to provide progressive energy dissipation with force-deflection curves optimized for specific impact scenarios.

### 2. Exterior Coverings

The exterior coverings, which can include a neck cover with circumference of 300-400 millimeters, a torso cover with surface area of 0.3-0.5 m², an upper leg cover extending 300-400 millimeters, a shin cover with tapered profile from 200 to 150 millimeters diameter, a foot cover with ventilation perforations of 2-5 millimeters diameter, a lower arm cover with twist accommodation of ±180 degrees, and a hand cover with finger articulation clearance of 5 millimeters, are designed not to interfere with the robot's range of motion by maintaining clearances above 3 millimeters at all joint positions, to allow access to underlying components through zippered or removable sections, to potentially add indicators with luminous intensity above 50 candelas to the external surface, and to improve the robot's overall aesthetic appearance through consistent surface texture and coloration. As shown in the FIGs., a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted with dimensional tolerances of ±5 millimeters in certain regions and may include different inserts (e.g., a different textile) with elastic modulus varying by 50-200% that are positioned between the moving aspects of joints to accommodate relative motion exceeding 100 millimeters.

Exterior coverings materials of the exterior covering assembly 1.2.16 can be made from one or more textiles with thread counts from 100 to 500 per inch and can be customized or selected to reduce wrinkling through prestressed construction and to allow for the twisting or movement of the underlying components without restriction defined as force below 5 Newtons or substantial distortion defined as strain below 10%. For example, the exterior coverings materials may be designed with four-way stretch capability to allow the lower arm to twist and rotate from about −120 degrees to about 180 degrees while maintaining return force below 10 Newtons. Additionally, the exterior coverings materials may be selected with air permeability above 50 cfm to allow for the cooling of components, the viewing of indicator lights through translucent regions with light transmission above 30%, or the operation of buttons with actuation force below 5 Newtons through said exterior coverings with deflection below 10 millimeters. This provides a substantial benefit over conventional systems that lack these advanced features and adaptability. It should be understood that this disclosure contemplates using or including exterior coverings materials that: (i) integrate lights with power consumption below 5 watts from the robot 1 into said exterior covering, and specifically into a textile itself through conductive fibers with resistance below 100 ohms per meter, (ii) may be translucent with light transmission from 10% to 60% or temporarily translucent (e.g., based on time with switching speeds below 100 milliseconds or environment with temperature thresholds at 25° C.), and/or (iii) can be formed (e.g., woven) with aperture sizes from 0.1 to 2 millimeters in a manner that allows light to be transmitted through the textile with minimal diffraction.

As such, various types of lights (e.g., fiber optic lighting with bend radius above 10 millimeters, led strip lights with pitch of 5-10 millimeters, led rope lights with viewing angles above 120 degrees, micro-led string lights with power consumption below 0.1 watts per element, led neon flex with color temperatures from 2700K to 6500K, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials with response time below 1 microsecond, electroluminescent paint with thickness of 50-200 micrometers, laser-illuminated fiber bunches with numerical aperture of 0.2-0.5, phosphor-coated electroluminescent (PCEL) materials with efficiency above 20 lumens per watt, smart RGB led strips with 16 million color combinations, light-up silicone tubing (LED or EL-based) with flexibility radius below 20 millimeters, laser wire with diameter below 1 millimeter, or other electroluminescent materials such as EL wire with diameter of 1-5 millimeters, EL tape with thickness below 0.5 millimeters, or EL film with surface area above 100 cm²) that are coupled to the humanoid robot 1 with electrical connections rated for 1 million flex cycles may be visible through the exterior coverings material with contrast ratios above 10:1. The exterior coverings material can include reflective yarn with retroreflectivity above 300 cd/lux/m² or night-luminous yarn with phosphorescent efficiency above 20% that changes its appearance when light above 100 lux is shining on its surface. In other embodiments, a shiny, reflective, iridescent, matte, or textured polyurethane film with thickness of 20-100 micrometers can be applied to the surface of the exterior coverings material (e.g., a textile) in certain areas with adhesion strength above 20 N/cm to provide an additional reflective effect with reflectance above 80% or for another purpose, such as displaying a logo with resolution above 300 dpi, pattern with repeat accuracy within 1 millimeter, or labels with text height above 5 millimeters.

The exterior coverings material can also include features to accommodate the thermal considerations of the robot 1 operating in ambient temperatures from −20° C. to +50° C. In various examples, the exterior coverings material can be a custom textile that utilizes different weaves with varying porosity from 10% to 40% in different locations to allow for ventilation with airflow rates from 5 to 50 cfm in specific areas where heat generation exceeds 20 watts per square decimeter. Additionally, the exterior coverings materials can include textiles or threads with thermochromic properties that are heat-sensitive and change color with a change in temperature at transition points between 25° C. and 40° C. with color shift completing within 2 seconds. In summary, the exterior coverings may additionally be made from, include, or specifically omit any one or any combination of the following material types: durable materials with abrasion resistance above 50,000 Martindale cycles, flame-resistant materials meeting UL94 V-0 rating, waterproof materials with hydrostatic head above 10,000 millimeters, hazard materials with high-visibility colors exceeding 200 cd/m², chemical-resistant materials withstanding pH from 2 to 12.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers with attenuation above 60 dB at 1 GHz, as well as modular, quick-release panels or e-textile technology with conductive fibers having resistance below 10 ohms per meter woven throughout to create a distributed sensor network with spatial resolution below 10 millimeters that is capable of detecting impacts above 10 Newtons, monitoring joint angles with accuracy of ±1 degree, or even harvesting energy from movement at rates above 1 milliwatt per square centimeter. The exterior covering assembly 1.2.16 may be designed to include inserts (which may also be textiles with different elastic moduli or may be other materials such as silicone with Shore A hardness of 30-70) that are positioned strategically between moving joint components with gaps of 5-20 millimeters to further ensure that pivoting motion with angular velocities up to 720 degrees per second is not restricted at the joints of the humanoid robot 1. Different textile materials with varying properties, patterns with stitch densities from 10 to 50 per centimeter, knits with gauge from 7 to 28, weaves with thread counts from 50 to 500 per inch, etc. may be incorporated to facilitate movement in specific regions with stretch percentages from 20% to 200%, thereby enhancing the functional dexterity of the robot 1 while maintaining structural integrity over 1 million movement cycles.

iii. Sensors

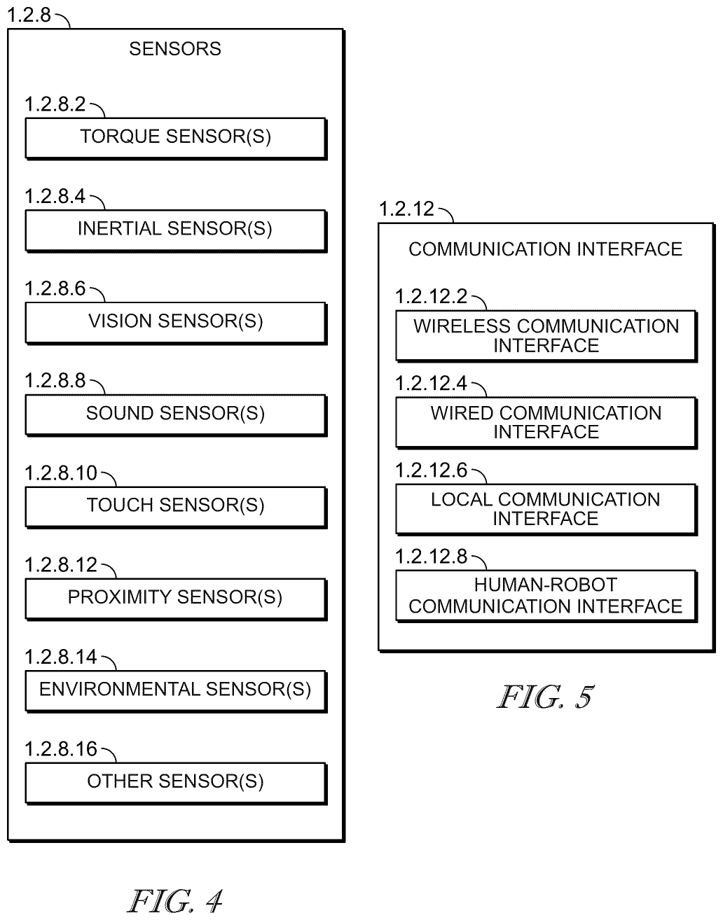

As illustrated in FIG. 4, sensors 1.2.8 may be embodied as any hardware, software, and/or circuitry for providing sensor data indicative of perceived stimuli, conditions, and measurements with update rates from 1 Hz to 10 kHz to enable the humanoid robot 1 to process information with latencies below 10 milliseconds, reason, and act appropriately (e.g., based on a given task, a set of rules, and/or other constraints). The sensors 1.2.8 may include one or more torque sensors 1.2.8.2 with resolution below 0.01 N-m, inertial sensors 1.2.8.4, visual sensors 1.2.8.6 with frame rates up to 120 fps, auditory sensors 1.2.8.8 with frequency response from 20 Hz to 20 kHz, touch sensors 1.2.8.10 with spatial resolution below 1 millimeter, proximity sensors 1.2.8.12 with detection ranges from 1 millimeter to 10 meters, environmental sensors 1.2.8.14 with measurement accuracy within 1% of reading, and other sensors 1.2.8.16. The sensors 1.2.8 may provide sensor data (e.g., torque measurements with 16-bit resolution, inertia measures with noise density below 0.001 degrees/second/√Hz, audiovisual sensor data with dynamic range above 120 dB, touch data with force resolution below 0.01 Newtons, proximity data with distance accuracy of ±1 millimeter, environmental data with temperature resolution of 0.1° C., etc.) to the compute 1.2.10 processors, further described below, to enable appropriate interaction between the humanoid robot 1 and the environment with reaction times below 100 milliseconds.

The torque sensors 1.2.8.2 may comprise one or more torque cells with measurement ranges from 0.1 to 500 Newton-meters that are positioned within the actuators and are designed to measure the amount of force or torque applied to a part of the humanoid robot 1 with sampling rates exceeding 1 kHz. The measurements with resolution better than 0.1% of full scale may be transmitted to other components of the humanoid robot 1 through digital interfaces operating at speeds above 10 Mbps, such as the whole body controller 1550 processing data at 1 kHz update rates or one or more controllers 1600 implementing control loops with bandwidths above 100 Hz, to enable balance with center of mass tracking within 5 millimeters, locomotion at speeds up to 2 meters per second, manipulation with force accuracy below 1 Newton, and handling by the humanoid robot 1 of objects ranging from 1 gram to 20 kilograms.

The inertial sensors 1.2.8.4 may comprise sensors for measuring the motion, position, and orientation of the humanoid robot 1 relative to the environment with update rates exceeding 200 Hz for purposes of navigation with positional accuracy below 10 centimeters, stabilization maintaining balance on surfaces with up to 15 degrees inclination, and interaction with the environment and surroundings including dynamic obstacle avoidance. For example, the inertial sensors 1.2.8.4 can include one or more accelerometers (e.g., to measure acceleration forces up to ±16 g in one or more directions for use in determining changes in velocity with resolution below 0.001 m/s² and orientation with angular accuracy below 0.1 degrees), gyroscopes (e.g., to measure angular velocity up to ±2000 degrees per second for use in tracking rotational movement with drift below 0.01 degrees per second and maintaining balance during perturbations up to 100 Newtons), IMUs (e.g., combining the accelerometers with range ±8 g and gyroscopes with range ±1000 degrees per second for use in providing comprehensive motion and orientation data with 9-axis sensing including magnetometers), and Global Positioning System (GPS) receivers (e.g., to provide location data with accuracy below 2 meters based on satellite signals from multiple constellations including GPS, GLONASS, Galileo, and BeiDou, for use in outdoor navigation and positioning with update rates of 10 Hz).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1 with combined horizontal field of view of 150 degrees.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

v. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1.2.10, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

### E. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in al particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/324,392, 19/325,486, 19/325,415, 19/324,342 and 19/329,474; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference.

1. A humanoid robot comprising:
an upper portion having: (i) a torso, (ii) a left elbow, (iii) a left fingertip, and (iv) a plurality of actuators that include:
four electrical actuators positioned between the left elbow and the left fingertip, and each actuator includes a motor with a momentary peak torque rating that is below 0.12 Nm,
two electrical actuators positioned between the torso and the left elbow, and each actuator includes a motor with a momentary peak torque rating that is above 1.3 Nm;
a lower portion having: (i) a shin, and (ii) a plurality of actuators that include an electrical actuator positioned within the shin and having a motor with a momentary peak torque rating that is above 0.75 Nm; and
a central portion extending between the upper portion and the lower portion, the central portion having: (i) a pelvis, and (ii) a plurality of actuators that include a hip flex electrical actuator that is directly coupled to the pelvis and has a motor with a momentary peak torque rating that is above 3.5 Nm.

2. The humanoid robot of claim 1, wherein the hip flex electrical actuator includes a hip flex axis with a downward sloping outward configuration, whereby a non-zero angle is formed between a transverse plane of the humanoid robot and the hip flex axis.

3. The humanoid robot of claim 2, wherein the central portion further includes a left knee actuator: (i) having a momentary peak torque is greater than 220 Nm, (ii) including a motor with an outer diameter that is equal to or less than 85 mm, and (iii) including a knee axis that is co-planar with the hip flex axis.

4. The humanoid robot of claim 1, wherein the central portion further includes a left hip roll actuator: (i) having a motor with a momentary peak torque rating that is equal to the momentary peak torque rating of the motor contained in the shin, (ii) directly coupled to the hip flex actuator, and (iii) includes a hip roll axis that have a downwardly sloping rearward configuration, whereby a non-zero angle is formed between a transverse plane of the humanoid robot and the hip roll axis.

5. The humanoid robot of claim 1, wherein the humanoid robot lacks both a dedicated torso pitch actuator and hydraulic actuators.

6. The humanoid robot of claim 1, wherein all actuators are positioned in the central portion and the lower portion include the same encoder configuration.

7. The humanoid robot of claim 1, wherein all actuators are positioned in the central portion and the lower portion include a strain wave gearbox and a through-bore opening formed in the center of the actuator.

8. The humanoid robot of claim 1, wherein a majority of the actuators in the upper portion include a brushless DC motor and an optical encoder with a resolution of at least 16 bits.

9. The humanoid robot of claim 1, wherein at least a majority of the actuators positioned in the central portion and the lower portion include a torque sensor with a measurement range between 0-500 Nm.

10. A humanoid robot comprising:
an upper portion having a plurality of actuators that include: (i) eight electrical actuators, each having a first momentary peak torque rating, (ii) four electrical actuators, each having a second momentary peak torque rating that is different from the first momentary peak torque, and (iii) four electrical actuators having a third momentary peak torque rating that is different from both the first and second momentary peak torques; and
a lower portion including two electrical actuators having a fourth momentary peak torque rating that is different than each of the first, second, and third momentary peak torques; and
a central portion extending between the upper portion and the lower portion, the central portion including two electrical actuators having a fifth momentary peak torque rating that is different than each of the first, second, third, and fourth momentary peak torques.

11. The humanoid robot of claim 10, further comprising a left elbow, a right elbow, a left fingertip, and a right fingertip, and wherein the eight electric actuators that have the first momentary peak torque rating are positioned between the left and right elbows and the left and right fingertips.

12. The humanoid robot of claim 11, wherein the four electrical actuators having the second momentary peak torque are positioned between the left and right elbows and the eight electric actuators.

13. The humanoid robot of claim 11, further comprising a torso, and wherein the four electrical actuators having the third momentary peak torque are positioned between the left and right elbows and the torso.

14. The humanoid robot of claim 10, further comprising a pelvis, and wherein the two electrical actuators having the fifth momentary peak torque are directly coupled to said pelvis and are the left and right hip flex actuators.

15. The humanoid robot of claim 14, wherein left and right hip flex actuators have a hip flex axis with a downward sloping outward configuration, whereby a non-zero angle is formed between a transverse plane of the humanoid robot and each respective hip flex axis.

16. The humanoid robot of claim 14, wherein the central portion further includes left and right knee actuators, and wherein each of the left and right knee actuators: (i) has the fifth momentary peak torque, and wherein said fifth momentary peak torque is greater than 220 Nm, (ii) including a motor with an outer diameter that is equal to or less than 85 mm, and (iii) have a knee axis that is aligned with a coronal plane of the humanoid robot.

17. The humanoid robot of claim 14, wherein the central portion further includes left and right hip roll actuators, and wherein each of the left and right hip actuators: (i) has a sixth momentary peak torque that is different from the first-fifth momentary peak torques, (ii) is directly coupled to the respective left and right hip flex actuators, and (iii) includes hip roll axis that have a downwardly sloping rearward configuration, whereby a non-zero angle is formed between a transverse plane of the humanoid robot and the hip roll axes.

18. A humanoid robot comprising:
an upper portion having: (i) a torso, (ii) a left elbow, and (iii) a plurality of actuators that include:
an electrical actuator having: (a) a portion positioned within the torso, (b) a motor with a momentary peak torque rating that is above 2.5 Nm, and (c) an arm axis that has a rearwardly sloped configuration, whereby a non-zero angle is formed between the arm axis and a coronal plane of the humanoid robot;
two electrical actuators are positioned between the torso and the left elbow, and each actuator includes a motor with a momentary peak torque rating that is above 1.3 Nm;
a lower portion having a plurality of actuators that include an electrical actuator with a motor with a momentary peak torque rating that is below 1 Nm; and
a central portion extending between the upper portion and the lower portion, the central portion having: (i) a pelvis, and (ii) a plurality of actuators that include a hip roll electrical actuator that has an extent that is positioned rearward of the pelvis and has a motor with a momentary peak torque rating that is above 2.5 Nm.

19. The humanoid robot of claim 18, further comprising a left hip flex actuator that is directly coupled to the pelvis and includes a hip flex axis with a downward sloping outward configuration, whereby a non-zero angle is formed between a transverse plane of the humanoid robot and the hip flex axis.

20. The humanoid robot of claim 19, wherein the central portion further includes left knee actuator including: (i) a momentary peak torque is greater than 220 Nm, (ii) a motor with an outer diameter that is equal to or less than 85 mm, and (iii) a knee axis that is aligned with the coronal plane of the humanoid robot.

21. The humanoid robot of claim 18, wherein the hip roll electrical actuator includes a hip roll axis that has a downwardly sloping rearward configuration, whereby a non-zero angle is formed between a transverse plane of the humanoid robot and the hip roll axis.
